(19) United States
(12) Patent Application Publication
(10) Pub. No.: US 2026/0331663 A1
(43) Pub. Date: Oct. 22, 2026

(54) BATTERY PACK

(71) Applicant: Panasonic Intellectual Property Management Co., Ltd., Osaka (JP)

(72) Inventor: KENSAKU TAKEDA, Tokushima (JP)

(21) Appl. No.: 19/486,372

(22) PCT Filed: May 10, 2024
(86) PCT No.: PCT/JP2024/017352

§ 371 Date: Nov. 20, 2025

(30) Foreign Application Priority Data
May 29, 2023 (JP) 2023-087707

(51) Int. Cl. H01M 50/213; H01M 50/107; H01M 50/271; H01M 50/289; H01M 50/342

(52) U.S. Cl. CPC H01M 50/213; H01M 50/107; H01M 50/271; H01M 50/289; H01M 50/3425

(57) ABSTRACT

A battery pack includes: a battery block that includes a battery cell that includes an opening of a discharge valve on a first end surface of the battery cell; and an outer covering case that houses the battery block. The outer covering case includes a recessed and protruding portion on an opposite surface of the outer covering case that is opposite to the first end surface of the battery cell. The recessed and protruding portion includes a top portion closer to the first end surface of the battery cell and a bottom portion that is farther away from the first end surface of the battery cell, and the top portion and the bottom portion are different in height in a direction perpendicular to the first end surface of the battery cell.

### TECHNICAL FIELD

The present disclosure relates to a battery pack that houses battery cells each including a discharge valve.

### BACKGROUND ART

A battery pack includes an outer covering case in which a plurality of battery cells are housed. A battery cell that includes a discharge valve is capable of preventing explosion of the battery cell by opening the discharge valve when an abnormality occurs. The discharge valve opens when the battery cell experiences thermal runaway and the internal pressure exceeds a threshold value. As a result, ejected matter including gas and substances ejected and discharged from the opening of the battery cell into the outer covering case reaches excessive high temperature and high pressure. This can damage the outer covering case in an abnormal condition. For example, a battery pack disclosed in, for example, Patent Literature (PTL) 1 includes heat-resistant plates on the inner surface of the outer covering case to avoid the risk of damage to the outer covering case in an abnormal condition.

### CITATION LIST

### Patent Literature

[PTL 1] Japanese Unexamined Patent Application Publication No. 2021-150082

### SUMMARY OF THE INVENTION

However, fire-resistant components, such as heat-resistant plates, are expensive, leading to high component costs. In addition, providing the fire-resistant components at predetermined positions in the case requires complicated configuration and assembly, resulting in an increased manufacturing cost. The battery pack according to PTL 1 includes, in the outer covering case, a plate-shaped heat-resistant plate disposed at a position opposite to the electrode end surface of each battery cell where the discharge valve has an opening, and an L-shaped heat-resistant plate at the corner of the outer covering case. The battery pack according to PTL 1 includes two heat-resistant plates that are a plate-shaped plate and an L-shaped plate, which further increases the component cost. In addition, since each heat-resistant plate is provided at a fixed position in the outer covering case, complicated configuration and assembly are required, leading to an increased manufacturing cost.

The present disclosure has been developed in order to solve the above-mentioned drawbacks of the battery pack described above. An object of the present disclosure is to provide a battery pack that reduces the risk of damaging the outer covering case in an abnormal condition while reducing costs.

A battery pack according to an aspect of the present disclosure includes: a battery block that includes a battery cell that includes an opening of a discharge valve on a first end surface of the battery cell; and an outer covering case that houses the battery block. The outer covering case includes a recessed and protruding portion on an opposite surface of the outer overing case that is opposite to the first end surface of the battery cell. The recessed and protruding portion includes a top portion that is closer to the first end surface of the battery cell and a bottom portion that is farther away from the first end surface of the battery cell. The top portion and the bottom portion are different in height in a direction perpendicular to the first end surface of the battery cell.

The battery pack described above is capable of reducing the risk of damaging the outer covering case in an abnormal condition while reducing costs.

### BRIEF DESCRIPTION OF THE DRAWINGS

FIG. 1 is a schematic perspective view of a battery pack according to an embodiment of the present disclosure.

FIG. 2 is a schematic exploded perspective view of a state in which an outer covering case in FIG. 1 is to be attached.

FIG. 3 is an exploded perspective view of the battery pack in FIG. 2.

FIG. 4 is a schematic perspective view of a recessed and protruding portion.

FIG. 5 is a cross-sectional perspective view of the battery pack in FIG. 1 taken along line VI-VI.

FIG. 6 is an enlarged cross-sectional view of relevant components of the battery pack in FIG. 1 taken along line VI-VI.

FIG. 7 is a cross-sectional perspective view of a recessed and protruding portion according to another example.

FIG. 8 is a schematic perspective view of a recessed and protruding portion according to another example.

FIG. 9 is a schematic perspective view of a recessed and protruding portion according to another example.

FIG. 10 is a schematic cross-sectional view of a recessed and protruding portion according to another example.

FIG. 11 is an enlarged cross-sectional view of relevant components of a recessed and protruding portion according to another example.

FIG. 12 is a schematic perspective view of a recessed and protruding portion according to another example.

FIG. 13 is a schematic perspective view of a recessed and protruding portion according to another example.

FIG. 14 is a schematic cross-sectional view of a recessed and protruding portion according to another example.

FIG. 15 is a schematic cross-sectional view of a recessed and protruding portion according to another example.

FIG. 16 is a schematic cross-sectional view of a recessed and protruding portion according to another example.

FIG. 17 is a schematic cross-sectional view of a recessed and protruding portion according to another example.

FIG. 18 is a schematic cross-sectional view of a recessed and protruding portion according to another example.

FIG. 19 is a schematic cross-sectional view illustrating a battery pack according to a comparative example in a state in which ejected matter ejected from an opening of a discharge valve of a battery cell travels toward corners.

FIG. 20 is a schematic perspective view illustrating positions of the corners of an outer covering case in the battery pack according to the comparative example.

### DESCRIPTION OF EMBODIMENTS

Aspects of the present disclosure may be identified by the following configuration and features.

A battery pack according to an aspect of the present disclosure includes: a battery block that includes a battery cell that includes an opening of a discharge valve on a first end surface of the battery cell; and an outer covering case that houses the battery block. The outer covering case includes a recessed and protruding portion on an opposite surface of the outer covering case that is opposite to the first end surface of the battery cell. The recessed and protruding portion includes a top portion that is closer to the first end surface of the battery cell and a bottom portion that is farther away from the first end surface of the battery cell. The top portion and the bottom portion are different in height in a direction perpendicular to the first end surface of the battery cell.

With the configuration above, it is possible to reduce the risk of damaging the outer covering case in an abnormal condition, while reducing costs. The configuration in which the recessed and protruding portion is provided on the opposite surface that is opposite to the first end surface of a battery cell does not require a separate component, such as a heat-resistant member. This leads to a reduction in component cost. In addition, complicated configuration or assembly is not required and any labor or processes for arranging the components in predetermined positions are not required, thus reducing the manufacturing costs. In the above configuration, the recessed and protruding portion is provided on the opposite surface that is opposite to the first end surface of a battery cell. This causes the ejected matter ejected from the discharge valve of the battery cell to collide and contact with and bounce off the recessed and protruding portion, and redirects, diffuses, and directs the ejected matter. This prevents and reduces the concentration and accumulation of the high-temperature and high-pressure ejected matter in specific locations, such as corners in the outer covering case. As a result, it is possible to reduce the risk of damaging the outer covering case in an abnormal condition.

In the battery pack according to another aspect of the present disclosure, it may be that the recessed and protruding portion includes one or more recesses or one or more protrusions. With the configuration above, it is possible to reduce the risk of damaging the outer covering case in an abnormal condition, while reducing costs. The recessed and protruding portion causes the ejected matter to collide and contact with and bounce off the protrusions and the recesses, and redirects and diffuses the ejected matter. The recessed and protruding portion also separates and disperses the ejected matter, causes the ejected matter to flow and travel in the recessed and protruding portion and directs the ejected matter. This prevents and reduces the concentration and accumulation of the high-temperature and high-pressure ejected matter in specific locations, such as corners. As a result, it is possible to reduce the risk of damaging the outer covering case in an abnormal condition.

In the battery pack according to another aspect of the present disclosure, it may be that a portion of the recessed and protruding portion overlaps with a line connecting the opening of the discharge value of the battery cell and a corner of an inner surface of the outer covering case. With the configuration above, it is possible to reduce the risk of damaging the outer covering case in an abnormal condition, while reducing costs. A portion of the recessed and protruding portion overlaps with a line connecting the opening of the discharge value of the battery cell and a corner of the inner surface of the outer covering case. This allows the recessed and protruding portion to be positioned in front of the corner relative to the traveling direction of the ejected matter traveling from the opening of the discharge valve. Therefore, it is possible to efficiently cause the collision, contact, bouncing, redirection, diffusion, inflow, flow, separation, and dispersion of the ejected matter. As a result, it is possible to prevent and reduce the concentration and accumulation of the high-temperature and high-pressure ejected matter in specific locations, such as corners.

In the battery pack according to another aspect of the present disclosure, it may be that the top portion of the recessed and protruding portion closer to the first end surface and the bottom portion of the recessed and protruding portion farther away from the first end surface are different in height by at least 1 mm. With the configuration above, it is possible to reduce the risk of damaging the outer covering case in an abnormal condition, while reducing costs. By increasing the difference in height in the recessed and protruding portion in the direction perpendicular to the first end surface, it is possible to increase the amount of collision and contact of the ejected matter compared to the case where the difference in height in the recessed and protruding portion is small, and to cause the recessed and protruding portion to serve as walls and grooves that reduce the straightness of the ejected matter. As a result, it is possible to prevent and reduce the concentration and accumulation of the high-temperature and high-pressure ejected matter in specific locations, such as corners.

In the battery pack according to another aspect of the present disclosure, it may be that the recessed and protruding portion includes a plurality of protrusions or a plurality of recesses, and the plurality of protrusions are different in height or the plurality of recesses are different in depth. With the configuration above, it is possible to reduce the risk of damaging the outer covering case in an abnormal condition, while reducing costs. Protrusions having different heights, for example, are formed by making an outer protrusion higher than an inner protrusion, and the amount of collision and contact of the ejected matter with the outer protrusion can be increased. In addition, it is possible to increase the area of the opening between the protrusions having different heights (recesses) compared to the area of opening between protrusions having the same height. This leads to an increase in the amount of collision, contact, inflow, and flow of the ejected matter. Moreover, protrusions having different heights and recesses having different depths can adjust the amount of collision, contact, inflow, and flow of the ejected matter. As a result, it is possible to prevent and reduce the concentration and accumulation of the high-temperature and high-pressure ejected matter in specific locations, such as corners.

In the battery pack according to another aspect of the present disclosure, it may be that the recessed and protruding portion includes a wall portion. With the configuration above, it is possible to reduce the risk of damaging the outer covering case in an abnormal condition, while reducing costs. A wall portion including a wall surface, such as a flat or curved surface, has a simple structure, facilitating the formation of a plurality of recessed and protruding shapes. The wall efficiently and reliably causes the ejected matter to collide and contact with and bounce off the wall surface, and redirects, separates, disperses, directs, and guides the ejected matter, so that the kinetic and thermal energy of the ejected matter is reduced and the ejected matter is diffused. As a result, it is possible to prevent and reduce the concentration and accumulation of the high-temperature and high-pressure ejected matter in specific locations, such as corners.

In the battery pack according to another aspect of the present disclosure, it may be that the recessed and protruding portion includes a curved surface that is curved toward a central axis of the battery cell. With the configuration above, it is possible to reduce the risk of damaging the outer covering case in an abnormal condition, while reducing costs. The curved surface can increase the length (area) of the recessed and protruding portion compared to the straight wall portion. As a result, it is possible to cause the collision, contact, dispersion, flow, and the like of the ejected matter. Moreover, it is possible to make the connected portion have a shape that does not include corners, such as a shape that has a gentle curved surface, unlike the straight wall portion. This prevents and reduces the concentration of the ejected matter.

In the battery pack according to another aspect of the present disclosure, it may be that an outermost periphery of the recessed and protruding portion is a highest protrusion that includes the curved surface. With the configuration above, it is possible to reduce the risk of damaging the outer covering case in an abnormal condition, while reducing costs. By providing the highest protrusion at the outermost periphery of the recessed and protruding portion, it is possible to cause the ejected matter traveling past the lower protrusions or the ejected matter traveling from the inner side of the recessed and protruding portion to collide with and bounce off the outermost highest protrusion, preventing the traveling of the ejected matter. As a result, it is possible to prevent and reduce the concentration and accumulation of the high-temperature and high-pressure ejected matter in specific locations, such as corners, and reduce the risk of damaging the outer covering case in an abnormal condition.

In the battery pack according to another aspect of the present disclosure, it may be that the recessed and protruding portion includes a tubular portion. With the configuration above, it is possible to reduce the risk of damaging the outer covering case in an abnormal condition, while reducing costs. Examples of the shape of the tubular portion include cylindrical, polygonal, elliptical, and irregular shape. A tubular portion that partially includes any of those shapes is also included. The tubular portion is inexpensive to manufacture, and the strength can be easily increased. The tubular portion has a simple configuration that facilitates the formation of the recessed and protruding shape according to the plurality of recesses and protrusions and the arrangement position. For example, by arranging the tubular portion concentrically with the central axis of the battery cell, the tubular portion can easily cover all directions including the corners behind the tubular portion. The curved surface of each of the cylindrical portions can increase the length (area) of the recessed and protruding portion compared to the straight wall portions, and has the same radius curvature and gentle curved surface. Therefore, the curved surface of each of the cylindrical portions has a shape that includes no connected portion between flat surfaces or no corner at the connected portion unlike the straight wall portions. As a result, it is possible to cause the collision, contact, dispersion, flow, and the like of the ejected matter, preventing and reducing the concentration of the ejected matter.

In the battery pack according to another aspect of the present disclosure, it may be that the recessed and protruding portion is shaped with a one-stroke drawing. With the configuration above, it is possible to reduce the risk of damaging the outer covering case in an abnormal condition, while reducing costs. The single-stroke shape is inexpensive to manufacture, the strength can be easily increased, and has a simple configuration that facilitates the formation of a plurality of recessed and protruding shapes. The single-stroke shape can increase the length (area) of the recessed and protruding portion compared to the straight wall portion, and has a gentle curved surface in a similar manner to the cylindrical portion. Therefore, the single-stroke shape includes no connected portion between flat surfaces or no corner at the connected portion unlike the straight wall portion. As a result, it is possible to cause the collision, contact, dispersion, flow, and the like of the ejected matter, preventing and reducing the concentration of the ejected matter.

In the battery pack according to another aspect of the present disclosure, it may be that the recessed and protruding portion includes a notch. With the configuration above, it is possible to reduce the risk of damaging the outer covering case in an abnormal condition, while reducing costs. The notch in the recessed and protruding portion can direct and guide the ejected matter in a direction away from the location where the ejected matter is likely to concentrate or in a safer direction.

In the battery pack according to another aspect of the present disclosure, it may be that the recessed and protruding portion includes an opening. With the configuration above, it is possible to reduce the risk of damaging the outer covering case in an abnormal condition, while reducing costs. The opening in the recessed and protruding portion can direct and guide the ejected matter in a direction away from the location where the ejected matter is likely to concentrate or in a safer direction.

In the battery pack according to another aspect of the present disclosure, it may be that the battery cell is a cylindrical battery. With the configuration above, it is possible to reduce the risk of damaging the outer covering case in an abnormal condition, while reducing costs.

Hereinafter, embodiments of the present disclosure will be described with reference to the drawings. In the following description, terms indicating specific directions and positions (e.g., “upper”, “lower”, and other terms including these terms) are used when necessary. These terms, however, are used to facilitate understanding of the invention with reference to the drawings, and the technical scope of the present disclosure is not limited by the meanings of these terms. Parts denoted by the same reference marks in a plurality of drawings represent the same or equivalent parts or components.

It should be further noted that exemplary embodiments to be descried below merely illustrate specific examples of the technical concept of the present disclosure, and therefore the present disclosure is not limited to the exemplary embodiments described below. Moreover, unless otherwise specified, dimensions, materials, shapes, relative arrangements, and the like of structural components described below are not intended to limit the scope of the present disclosure but are intended to be illustrative. The descriptive contents of one exemplary embodiment or example may apply to other exemplary embodiments or examples. In addition, sizes, positional relationships, and the like of components shown in drawings may be exaggerated to give a clear description.

### Embodiment 1

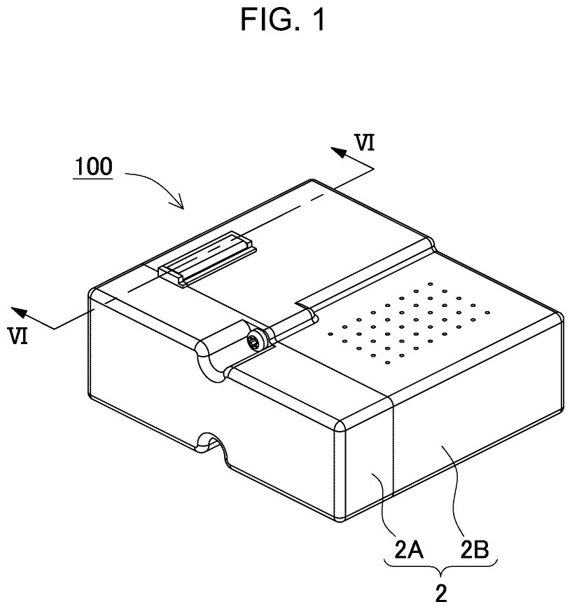

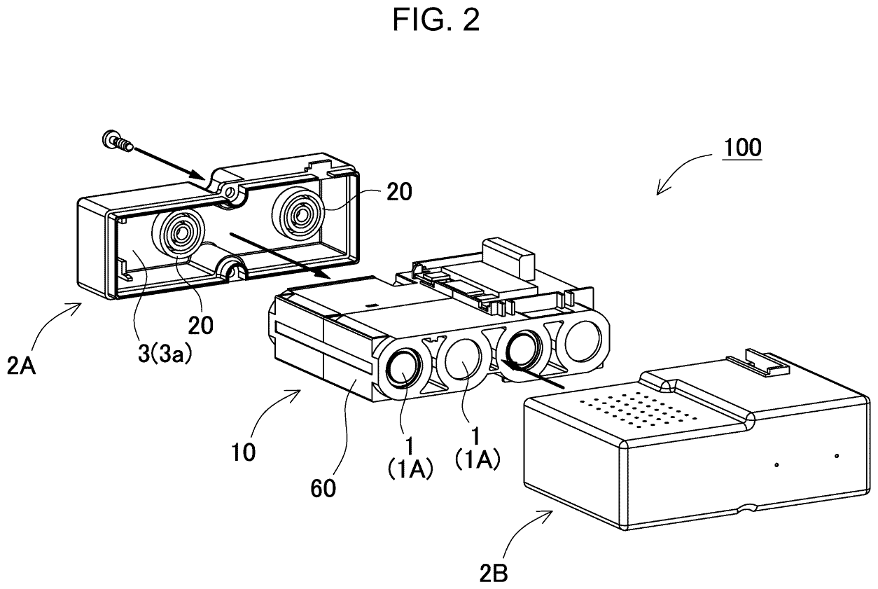

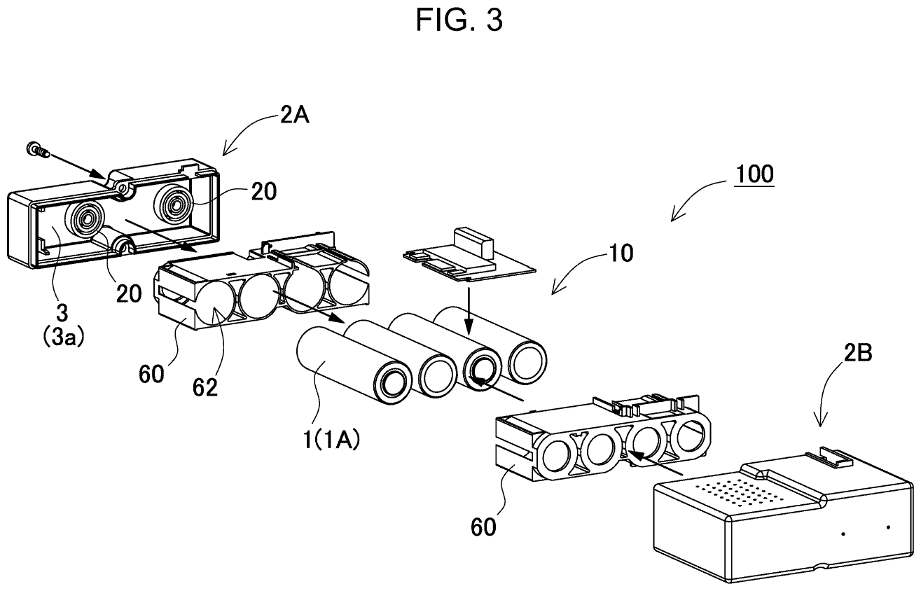

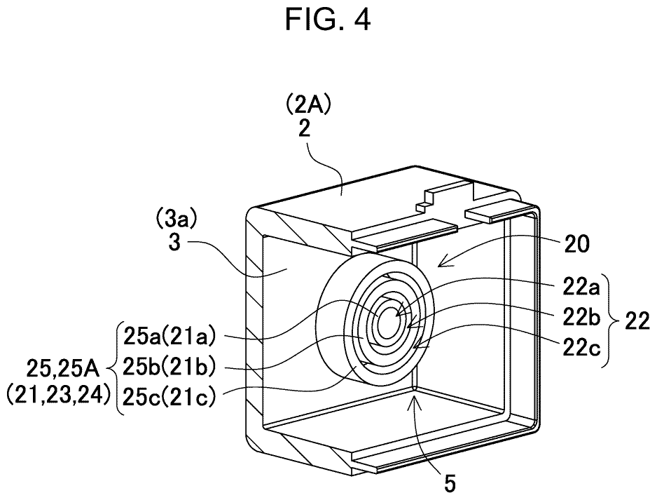

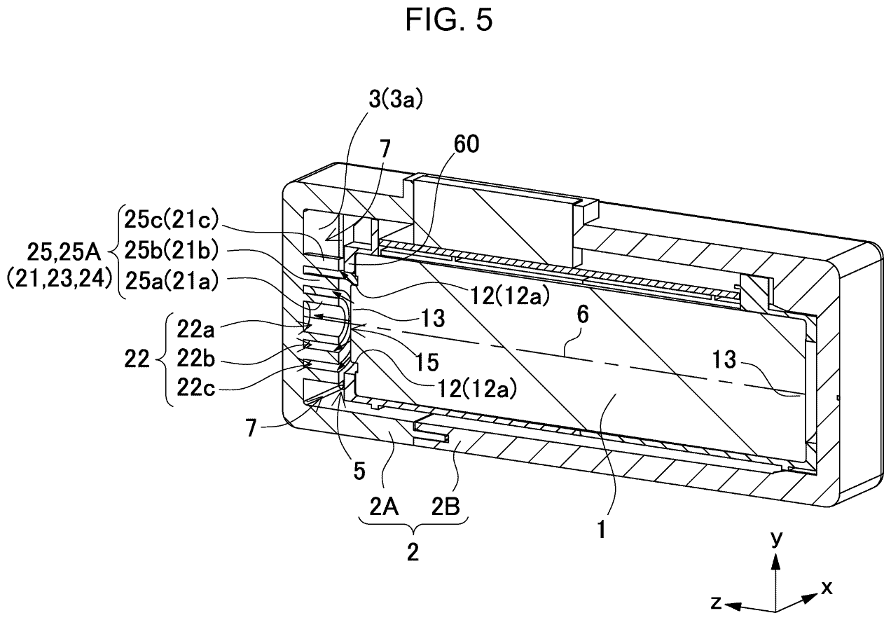

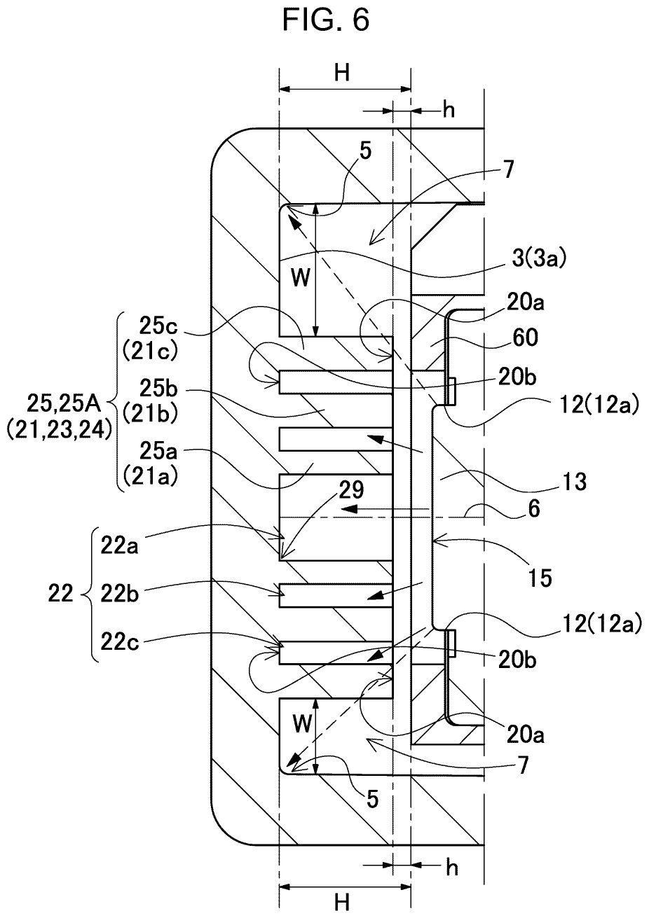

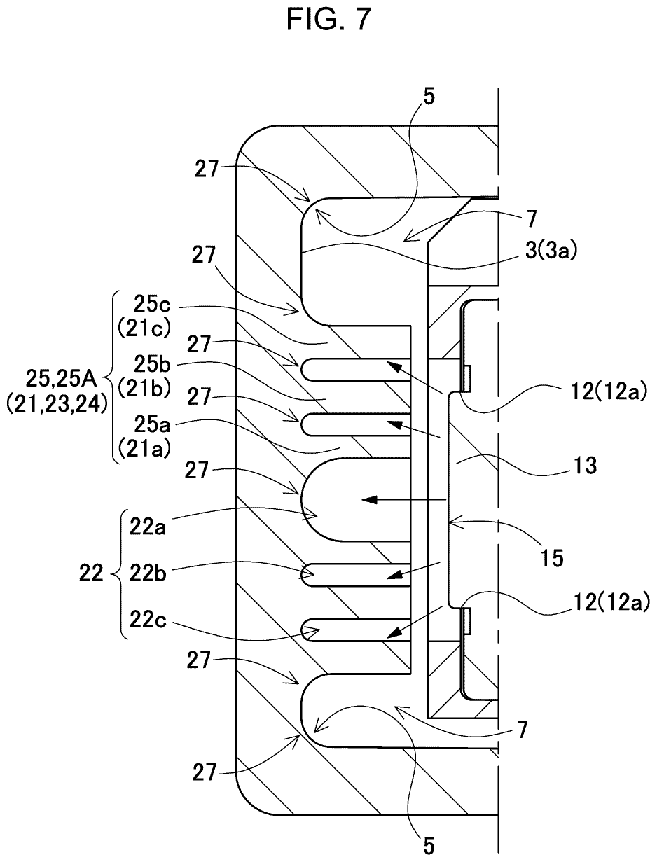

FIG. 1 to FIG. 11 illustrate battery pack 100 according to Embodiment 1 of the present disclosure. FIG. 1 is a perspective view of battery pack 100. FIG. 2 and FIG. 3 each illustrate an exploded perspective view of a state in which outer covering case 2 is to be attached. FIG. 4 illustrates a schematic perspective view of recessed and protruding portion 20. FIG. 5 and FIG. 6 each illustrate a cross-sectional view of battery pack 100 taken along line VI-VI (enlarged view of relevant components). FIG. 7 to FIG. 11 illustrate schematic perspective views and schematic cross-sectional views of recessed and protruding portions 20 according to other examples.

### Battery Block 10

Battery pack 100 includes battery block 10 that includes a plurality of battery cells 1 and outer covering case 2 that has a closed structure in which battery block 10 is housed. Battery block 10 includes a plurality of battery cells 1 which are disposed at fixed positions by battery holder 60, and are connected in parallel or series by lead plates. A lithium-ion battery including a large charge and discharge capacity relative to the weight and volume is suitable for battery cell 1. Lithium-ion batteries are capable of increasing the charge and discharge capacity of battery pack 100 while reducing the external size and weight of battery pack 100. However, battery pack 100 according to the present disclosure does not limit battery cells 1 to lithium-ion batteries. All batteries that can be charged, such as other rechargeable batteries, e.g., other non-aqueous electrolyte rechargeable batteries or solid-state batteries, can be used for battery pack 100.

Battery pack 100 can use non-aqueous rechargeable batteries, such as lithium-ion battery cells, to achieve high capacity while reducing weight. However, when this type of battery pack 100 is used under an abnormal condition, the internal pressure of battery cell 1 increases, leading to an explosion. In order to prevent this from happening, battery pack 100 includes discharge valves 12. Each discharge valve 12 opens when the internal pressure exceeds a threshold value and discharges the ejected matter through opening 12a. The ejected matter discharged from battery cell 1 has a high temperature and a high pressure, and can cause various thermal failures. The ejected matter includes both tangible and intangible objects. For example, the ejected matter includes contents such as vaporized electrolyte. The ejected matter can include solid or liquid as well as gas such as ejected gas. Examples of the thermal failure caused by the ejected matter include that outer covering case 2 is thermally damaged, thermal runaway of adjacent battery cell 1 is induced, and high-temperature ejected matter is discharged to the outside of outer covering case 2, leading to ignition or the like.

Battery cell 1 includes positive electrode 13 at an end and negative electrode 13 at the other end. Each battery cell 1 illustrated in FIG. 2 and FIG. 3 is cylindrical battery 1A that includes opening 12a of discharge valve 12 on first end surface 15 of battery cell 1. First end surface 15 of discharge valve 12 is, for example, the positive electrode side. First end surface 15 of battery cell 1 is the ejecting end surface from which ejected matter is ejected. The side of battery cell 1 opposite to the ejecting end surface is a non-ejecting end surface which does not include opening 12a of discharge valve 12 and from which the ejected matter is not ejected. Although each battery cell 1 in battery block 10 illustrated in FIG. 3 is cylindrical battery 1A, battery cell 1 is not limited to cylindrical battery 1A. A battery that includes opening 12a of discharge valve 12 on first end surface 15 of the battery, for example, a prismatic battery, can also be used as battery cell 1. A cylindrical battery includes an outer covering can formed by pressing a metal plate. The opening of the outer covering can is airtightly sealed by a sealing plate. The sealing plate includes opening 12a of discharge valve 12, and serves as first end surface 15 of battery cell 1. It may be that the battery cell includes an opening of the discharge valve in the bottom plate of the outer covering can. Therefore, the bottom face of the outer covering can including the opening of the discharge valve may serve as the first end surface with the opening of the discharge valve.

FIG. 2 and FIG. 3 illustrate examples of battery block 10. In battery block 10 illustrated in FIG. 3, battery cells 1 are arranged in parallel with each other and electrodes 13 on the respective ends of battery cells 1 are arranged on the same planes. Battery block 10 includes lead plates on the side opposite to electrodes 13 of battery cells 1, so that the lead plates connect battery cells 1 in series or in parallel. In the example such as FIG. 3, battery block 10 includes one unit with four battery cells 1 connected by the lead plates, and the ejecting and non-ejecting end surfaces of adjacent battery cells 1 are arranged alternately. In other words, the positive and negative electrodes of adjacent battery cells 1 are arranged in an alternating manner. However, the present disclosure does not limit the number of battery cells, arrangement direction, arrangement orientation, connection method, connection mode and the like. For example, the first end surfaces of the battery cells can be arranged on the same plane.

As illustrated in the exploded perspective view in FIG. 3, battery block 10 includes a plurality of battery cells 1 that are inserted into battery holder 60 and are arranged at the fixed positions without misalignment. Battery holder 60 is made of thermoplastic plastic, for example, and respective battery cells 1 are arranged in parallel in battery holder 60. Polycarbonate that is excellent in strength and heat resistance properties is suitable for thermoplastic plastic for battery holder 60. Other thermoplastic plastics that are excellent in strength and heat resistance properties can be used for battery holder 60. Battery holder 60 in FIG. 3 includes insertion tubes 62 that place battery cells 1 at the fixed positions.

### Outer Covering Case 2

Outer covering case 2 is a case or a cover in which battery block 10 is housed in a closed manner. Outer covering case 2 includes an inner wall that covers battery block 10, and is formed, for example, by molding thermoplastic plastic. The plastic of outer covering case 2 can be thermoplastic plastic having a high heat resistance temperature and a high strength, such as high-density polyethylene, polypropylene, polyimide, or polycarbonate. Outer covering case 2 illustrated in the exploded perspective views of FIG. 2 and FIG. 3 includes a pair of divided cases 2A and 2B connected to each other at the edges of the openings to arrange and house battery block 10 in outer covering case 2. Divided cases 2A and 2B each are formed by molding plastic into a box shape. Divided cases 2A and 2B in FIG. 2 and FIG. 3 include two sets of screw-fastening portions at the edges of the openings of the boxes, so that divided cases 2A and 2B are screw-fastened. This structure can reliably connect a pair of divided cases 2A and 2B to each other without misalignment. However, the present disclosure does not limit the structure, configuration, connection method and the like of the outer covering case. The outer covering case according to the present disclosure may be an outer covering case of any structure that can arrange and house battery block 10 in a closed manner. For example, outer covering case 2 may be used as an inner case. In this case, an additional outer covering case, such as a case or cover, can be provided to cover or house outer covering case 2. Outer covering case 2 may be used as an outer case (or an outermost case).

The high-temperature and high-pressure ejected matter ejected from the opening of the discharge valve on the first end surface of a battery cell may concentrate in specific locations, thermally damaging the outer covering case. By the ejected matter further penetrating the outer covering case, the ejected matter may be ejected to the outside of the outer covering case. The high-temperature and high-pressure ejected matter immediately after being ejected tends to concentrate in the corners inside the outer covering case. This results in a localized increase in pressure, which increases the likelihood of causing damages to the outer covering case. In a battery pack with a configuration with an increased closedness of the outer covering case in which the battery cells are housed, the risk increases when high pressure and high temperature occur due to an abnormality inside a battery. As the energy density of batteries increases, it is becoming more important to increase the safety of battery packs at a lower cost.

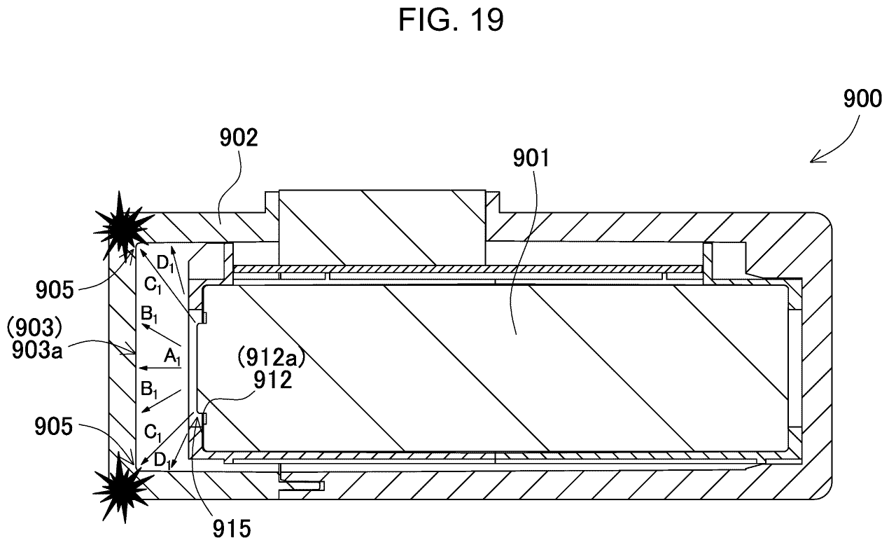

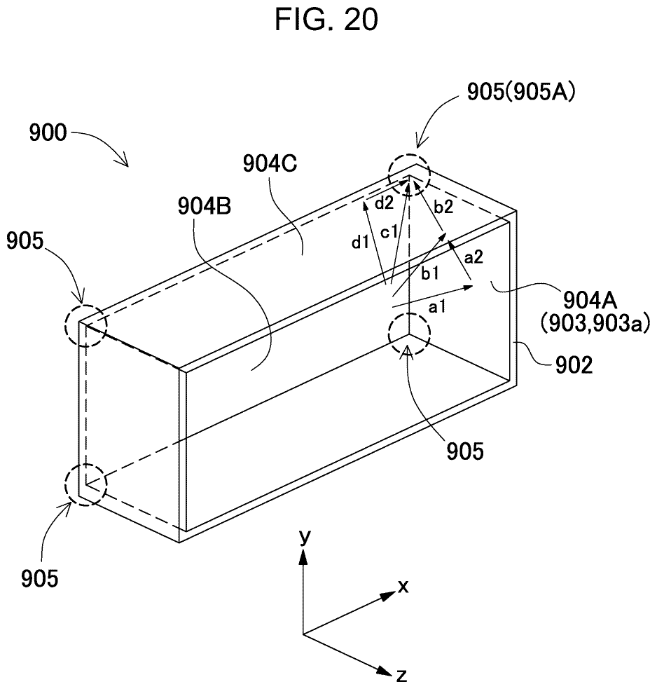

FIG. 19 and FIG. 20 each schematically illustrate battery pack 900 with no recessed and protruding portion according to a comparative example in a state in which ejected matter is ejected. FIG. 19 illustrates a state in which ejected matter is forcefully ejected from first end surface 915 of battery cell 901 toward opposite surface 903a (the inner surface of first wall 903 of outer covering case 902) opposite to first end surface 915. The ejected matter may be ejected forcefully in a wide angle from opening 912a of discharge valve 912 of battery cell 901 (e.g., arrows A1, B1, C1, and D1). After colliding with opposite surface 903a of first wall 903 (arrows A1 and B1), the ejected matter repeatedly bounces off or flows along opposite surface 903a and travels toward corners 905.

In such a way, the high-temperature and high-pressure gas and ejected matter ejected from battery cell 901 repeatedly collide with and bounce off the inner surface of outer covering case 902 and are likely to concentrate in corners 905, in particular, when the outer covering case is rectangular in shape. FIG. 20 illustrates the positions of corners 905 of outer covering case 902 in battery pack 900 according to the comparative example. In the case of rectangular outer covering case 902, each corner 905 is surrounded by three inner walls (inner surfaces) connected at right angles. The ejected matter is supplied to corners 905 one after another, and the ejected matter tends to concentrate and accumulate. For example, a description will be given of the case where the ejected matter concentrates in upper right corner 905A in FIG. 20. Corner 905A is surrounded by three inner surfaces (inner walls) which are two side surfaces that are first side wall 904A and second side wall 904B and top surface 904C that are perpendicularly connected to each other. It is assumed that ejected matter is ejected from first end surface 915 of battery cell 901 in the direction of arrows a1, b1, c1, d1, and the like. In this case, first side wall 904A serves an inner surface (first wall 903) including opposite surface 903a that is opposite to first end surface 915 of battery cell 901. The ejected matter ejected from first end surface 915 travels straight and collides with opposite surface 903a of first side wall 904A (first wall 903) (arrows a1 and b1), repeatedly bounces off opposite surface 903a or travels along first side wall 904A toward corner 905A (arrows a2 and b2), and collides with the other walls surrounding corner 905A (second side wall 904B and top surface 904C). The ejected matter also travels directly toward corner 905A (arrow c1). The ejected matter collides with and repeatedly bounces off second side wall 904B (arrow d1), top surface 904C, or other objects in outer covering case 902, the ejected matter that has contacted also repeatedly performs bouncing and collides with the other walls of corner 905A, or travels along second side wall 904B or top surface 904C toward corner 905A (arrow d2) and collides with the other walls of corner 905A. In view of the above, in the present embodiment, recessed and protruding portion 20 is provided to alleviate such excessive concentration of the ejected matter in corners 5, thereby reducing and inhibiting the risk of damaging outer covering case 2.

### Recessed and Protruding Portion 20

Recessed and protruding portion 20 is recesses and protrusions provided on the inner surface of outer covering case 2, as illustrated in FIG. 5 and the like. Recessed and protruding portion 20 is provided on opposite surface 3a of first wall 3 that is opposite to first end surface 15 of battery cell 1. The inner surface of first wall 3 of outer covering case 2 includes opposite surface 3a that is opposite to first end surface 15 of battery cell 1, and opposite surface 3a of first wall 3 includes recessed and protruding portion 20. Recessed and protruding portion 20 includes top portions 20a of protrusions 21 positioned closer to first end surface 15 and bottom portions 20b of recesses 22 positioned farther away from first end surface 15. Top portions 20a and bottom portions 20b in recessed and protruding portion 20 are different in height in a direction perpendicular to first end surface 15. There is a difference in height between top portions 20a and bottom portions 20b in recessed and protruding portion 20. The perpendicular width of first wall 3 of outer covering case 2 including recessed and protruding portion 20 relative to first end surface 15 is not uniform and varies due to the protrusions and recesses of recessed and protruding portion 20. In the direction perpendicular to first end surface 15, the width from the outer surface of first wall 3 to top portion 20a of recessed and protruding portion 20 is different from the width from the outer surface of first wall 3 to bottom portion 20b of recessed and protruding portion 20.

Recessed and protruding portion 20 includes at least protrusion 21 or recess 22. Protrusion 21 is a protruding or raised portion on opposite surface 3a. Recess 22 is a recessed portion, a groove portion, or a portion provided between protrusions 21 on opposite surface 3a. The width of first wall 3 including recessed and protruding portion 20 in the direction perpendicular to first end surface 15 is greater at top portion 20a of protrusion 21 than at the other portions, and is less at bottom portion 20b of recess 22 than at the other portions. When the width of first wall 3 of outer covering case 2 including recessed and protruding portion 20 in the direction perpendicular to first end surface 15 is expressed as the thickness of first wall 3 of outer covering case 2 including recessed and protruding portion 20, the thickness of first wall 3 of outer covering case 2 including recessed and protruding portion 20 varies, and recessed and protruding portion 20 is defined by the difference in thicknesses.

As illustrated in FIG. 5 and FIG. 6, protrusions 21 reduce the kinetic and thermal energy of the ejected matter by causing the ejected matter to collide and contact with and bounce off protrusions 21, and redirecting and diffusing the ejected matter in a plurality of directions. When each protrusion 21 is, for example, wall portion 23 that includes a wall surface with which the ejected matter collide, as described below, wall portion 23 acts as an obstacle and prevents and reduces that the ejected matter directly hits and is directly supplied to corners 5 positioned behind wall portion 23. Protrusion 21 of wall portion 23 serves as a wall with which the ejected matter collides. The ejected matter collides with and bounces off protrusion 21, and is redirected and diffused. Protrusion 21 diverts the ejected matter that has collided or contacted with protrusion 21, impeding the straightness of the ejected matter and reducing the flow velocity, and causes the ejected matter to flow along and contact with protrusion 21. As a result, the kinetic and thermal energy of the ejected matter can be reduced or gradually reduced. Protrusions 21 reduce the amount of ejected matter supplied to corners 5 and extend the time required for the ejected matter to flow to and reach corners 5. This prevents and reduces damages caused by the concentration and accumulation of the high-temperature and high-pressure ejected matter in corners 5. Protrusions 21 also divide and separate the ejected matter that is ejected one after another in a short period of time immediately after the ejection, so that the supply of a mass of high-temperature and high-pressure ejected matter to corners 5 is reduced or inhibited. Protrusions 21 cause the ejected matter to collide and contact with, and bounce off protrusions 21, and redirect and diffuse the ejected matter. Protrusions 21 serve as an obstacle for the flow path of the ejected matter that will accumulate to block and divert the traveling of the ejected matter and separate and disperse the supply path of the ejected matter. This reduces the kinetic and thermal energy of the ejected matter, leading to a reduced amount of high-temperature and high-pressure ejected matter supplied to corners 5. Higher protrusions 21 allow a larger amount of ejected matter to collide and contact with protrusions 21 than lower protrusions 21 do. It is possible to make each recess 22 provided between higher protrusions 21 deeper, allowing a larger amount of ejected matter to flow into deeper recess 22 than recess 22 between lower protrusions 21.

Each recess 22 is a recessed portion or a grooved portion provided in opposite surface 3a or a portion or region provided between protrusions 21. Recess 22 is surrounded by walls on both sides (wall portion 23 of protrusions 21) and a bottom. Recess 22 also prevents and reduces the concentration and accumulation of the ejected matter in corners 5. Recesses 22 cause the ejected matter to collide and contact with and bounce off any of the walls, and redirect and diffuse the ejected matter. This reduces the kinetic and thermal energy of the ejected matter. Recesses 22 cause the ejected matter traveling from the upper direction to flow toward the bottom while repeatedly causing the ejected matter to collide with and bounce off the wall. Recesses 22 further repeatedly cause the ejected matter to collide with and bounce off the bottom and walls, and cause the ejected matter to flow and travel along recesses 22. By doing so, the kinetic and thermal energy of the ejected matter can be reduced. Recesses 22 cause the ejected matter to flow into recesses 22, separate and divide the ejected matter, and guide the ejected matter in a specific direction, so that the ejected matter can be dispersed and diffused while reducing the kinetic and thermal energy of the ejected matter. As a result, recesses 22 reduce the amount of ejected matter supplied to corners 5 and extend the time required for the ejected matter to flow to and reach corners 5. This prevents and reduces damages caused by the concentration and accumulation of the high-temperature and high-pressure ejected matter in corners 5. The wider recesses 22 (the longer the interval between protrusions 21), the greater the amount of collision and contact of the ejected matter and the greater the amount of flow of the ejected matter into and along recesses 22. The deeper recesses 22, the greater the amount of flow of the ejected matter. The greater the number of recesses 22, the further the ejected matter can be separated, divided, and dispersed. Recesses 22 cause the ejected matter to collide and contact with the walls and flow into recesses 22. Recesses 22 cause the ejected matter to travel and move by repeatedly causing the ejected matter to collide and contact with, and bounce off the walls and bottom of recesses 22 and redirect and diffuse the ejected matter, so that the kinetic and thermal energy of the ejected matter is reduced. In addition, each recess 22 divides, disperses, and diffuses the ejected matter and causes the ejected matter to flow out from a position different from the position where the ejected matter flew in. As a result, it is possible to prevent and reduce the concentration and accumulation of high-temperature and high-pressure ejected matter in corners 5.

Recessed and protruding portion 20 includes a plurality of protrusions 21 and a plurality of recesses 22 arranged alternately. This further reduces the kinetic and thermal energy of the ejected matter and increases the diffusing and dispersing effects of the ejected matter. As a result, it is possible to prevent and reduce the concentration and accumulation of high-temperature and high-pressure ejected matter in corners 5. Recessed and protruding portion 20 with a plurality of protrusions 21 and a plurality of recesses 22 arranged alternately provides significant resistance to the traveling of the ejected matter, leading to an increased buffering effect. In particular, the orientation and arrangement of recessed and protruding portion 20 including a plurality of protrusions 21 and a plurality of recesses 22 and having a recessed and protruding shape in the direction of central axis 6 (Z-direction) of battery cell 1 from opposite surface 3a that is opposite to first end surface 15 of battery cell 1 cause the ejected matter ejected from first end surface 15 of battery cell 1 toward opposite surface 3a to repeatedly contact with and bounce off the recesses and the protrusions, and to further repeatedly contact with and bounce off the recesses and the protrusions while the ejected matter is separated, traveling, and is directed. With this, recessed and protruding portion 20 provides significant resistance to the traveling of the ejected matter, and reduces the kinetic and thermal energy of the ejected matter, preventing and reducing the concentration and accumulation of the high-temperature and high-pressure ejected matter in corners 5. The ejected matter ejected one after another from first end surface 15 of battery cell 1 passes through the physical recessed and protruding shape of recessed and protruding portion 20, so that the ejected matter can be diffused while reducing the kinetic and thermal energy of the ejected matter. Being pressed by the pressure of the ejected matter enhances the effects. Furthermore, by providing the plurality of protrusions 21 and the plurality of recesses 22 while ensuring the width that allows the high-temperature and high-pressure ejected matter to flow in and travel, for example, by arranging a plurality of wall portion 23 and elongated groove-shaped recesses 22 close to each other, the effects of separating and dividing the ejected matter are enhanced. In addition, the ejected matter flows into and travel along recesses 22, and the kinetic and thermal energy of the ejected matter is reduced and the ejected matter can be diffused and dispersed. The amount of high-temperature and high-pressure ejected matter supplied to corners 5 can be reduced and the time required for the ejected matter to reach corners 5 is extended. As a result, the concentration and accumulation of the high-temperature and high-pressure ejected matter in corners 5 can be prevented and reduced. Accordingly, recessed and protruding portion 20 including a plurality of protrusions 21 and a plurality of recesses 22 avoids the concentration of the high-temperature and high-pressure ejected matter in corners 5, and prevents outer covering case 2 from being damaged by the concentration of the high-temperature and high-pressure ejected matter. Thin protrusions 21 and narrow recesses 22 facilitate arrangement of a plurality of protrusions 21 and a plurality of recesses 22, and allows a large number of protrusions 21 and recesses 22 to be provided. By providing a plurality of thin wall portion 23 and elongated groove-shaped recesses 22, resistance to the traveling of the ejected matter can be increased, preventing and reducing the concentration and accumulation of the ejected matter in the corners. Recessed and protruding portion 20 has a simple configuration and physical shape that is the recessed and protruding shape on opposite surface 3a of first wall 3. This avoids and prevents the concentration of the high-temperature and high-pressure ejected matter at a low cost. By providing recessed and protruding portion 20 on opposite surface 3a, it is possible to efficiently achieve the configuration in which outer covering case 2, in particular, corners 5, can withstand the peak condition of the high-temperature and high-pressure ejected matter.

Recessed and protruding portion 20 does not require heat-resistant components, and its recessed and protruding shape, that is a simple structure and configuration, reduces the component and manufacturing costs. Recessed and protruding portion 20 also prevents and reduces the concentration of the ejected matter in specific locations, such as corners 5, to avoid the harmful effects of thermal runaway. However, heat-resistant components may be disposed.

In addition, the recessed and protruding shape of recessed and protruding portion 20 prevents and reduces the diffusion of the ejected matter, reduces the kinetic and thermal energy of the ejected matter, and directs the ejected matter. This reduces and prevents the flow of the ejected matter to battery cell 1 adjacent to battery cell 1 from which the ejected matter is ejected, and also reduces the kinetic and thermal energy of the ejected matter. In this respect, too, the harmful effects of thermal runaway can be avoided.

Recessed and protruding portion 20 can include one or more recesses 22 or one or more protrusions 21. The plurality of recesses 22 or the plurality of protrusions 21 may have the same or different sizes, shapes, thicknesses, heights, interval, widths or the like. The plurality of protrusions 21 are arranged in approximately parallel to each other, so that recesses 22 are provided between the plurality of protrusions 21. Recessed and protruding portion 20 in FIG. 4 includes three cylindrical protrusions 21 having different diameters and three recesses 22 between protrusions 21. Protrusions 21 include first protrusion 21a, second protrusion 21b, and third protrusion 21c from the center, and recesses 22 include first recess 22a, second recess 22b, and third recess 22c from the center. Recessed and protruding portion 20 is not limited to the configuration, shape, number, arrangement, and the like illustrated in the figures. For example, the inner surface of the outer covering case can be recessed or grooved to form recesses, and the recesses and protrusions can be combined. The recessed and protruding portion can be provided in appropriate shapes, sizes, heights (depths), intervals (widths), thicknesses, numbers, and arrangements according to the positional relationship with the first end surface of the battery cell, the opening of the discharge valve, the amount of ejected matter, the direction in which the ejected matter is ejected, the space around the battery cell, the distance to corners and inner walls, the distance to other collision objects, and the positional relationship with these.

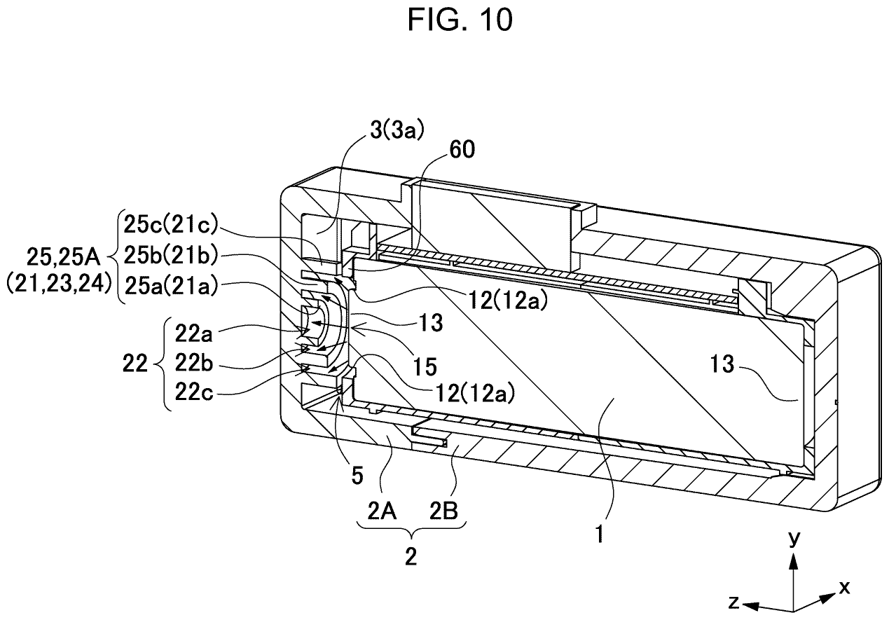

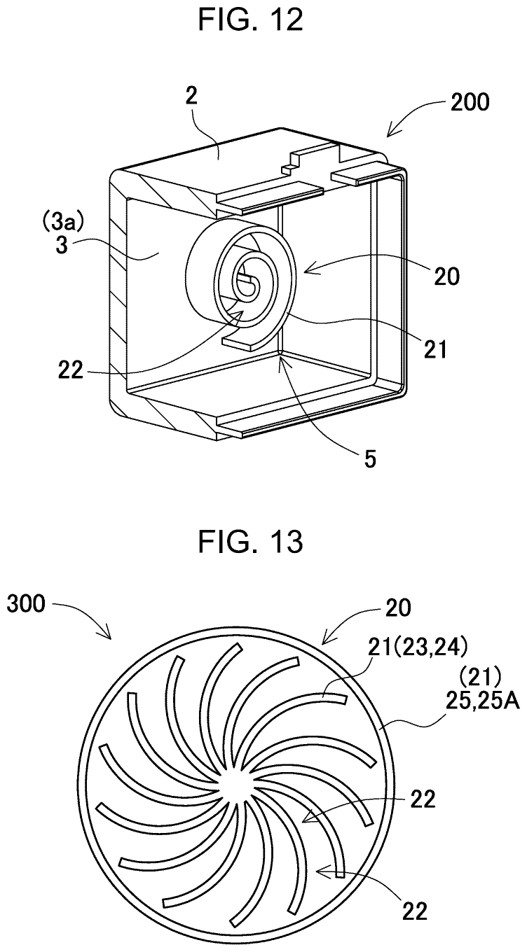

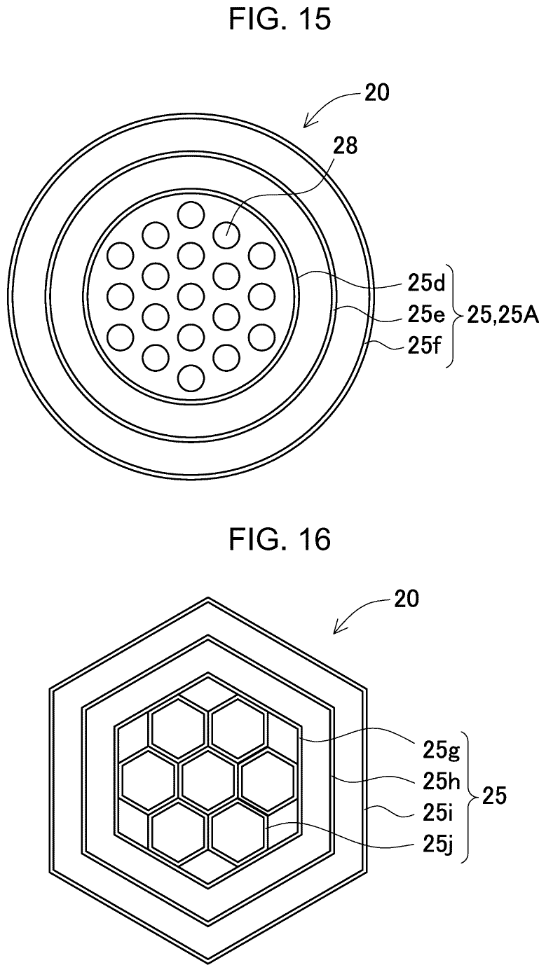

Each protrusion 21 is a protruding or raised portion on opposite surface 3a. Top portion 20a of protrusion 21 protrudes relative to the bottom of protrusion 21 (connected portion 29) and bottom portion 20b of recess 22. Protrusions 21 in FIG. 4 and the like include wall-shaped wall portion 23. Each wall portion 23 may be flat (e.g., FIG. 16 to FIG. 18), curved (e.g., FIG. 4, FIG. 10, FIG. 12, FIG. 13), or a combination of flat and curved surfaces. The same is true for the walls of recesses 22. Flat or curved wall portion 23 are capable of efficiently causing the ejected matter that has collided and contacted with the wall surfaces to bounce off wall portion 23, be redirected and diffused. In addition, wall portion 23 are capable of dividing and dispersing the ejected matter, causing the ejected matter to travel along the wall surfaces of wall portion 23 or into recesses 22 and to flow, and directing and guiding the ejected matter along protrusions 21 and recesses 22. Immediately after the ejection from battery cell 1, the ejected matter is ejected one after the other. This encourages the collision and contact of the ejected matter with recessed and protruding portion 20, and separation, inflow, and flow of the ejected matter. During this, the ejected matter repeatedly collides with and bounces off recessed and protruding portion 20. As a result, the ejected matter with reduced kinetic and thermal energy can be diffused and dispersed in all directions. Recessed and protruding portion 20 of wall portion 23 prevents the concentration of the ejected matter by not having a shape that facilitates the concentration of the ejected matter, such as a shape in which three or more surfaces are connected at approximately right angles. The shape of the wall surface, and the thickness, size, arrangement, inclination, orientation, and the like of wall portion 23 are not limited. Each wall portion 23 can include recesses and protrusions, notches 26a, openings 26b, and the like on the wall surface. Walls 23 can have different thicknesses. Walls 23 can be inclined, and can be tapered.

For example, protrusions 21 in FIG. 4 to FIG. 6 include cylindrical wall portion 23. The ejected matter ejected from battery cell 1 collides and contacts with the inner surface (on the right-side surface closer to central axis 6 in FIG. 5) of wall portion 23 in FIG. 5, e.g., third protrusion 21c on the left side in FIG. 5, and third protrusion 21c blocks the traveling of the ejected matter. As a result, it is possible to prevent and reduce the concentration of high-temperature and high-pressure ejected matter in corner 5 (corner 5 on the left in FIG. 5) which is located on the outer side behind the outer surface of third protrusion 21c. Wall portion 23 in FIG. 5, e.g., third protrusion 21c on the left side, serves as an obstacle to prevent the ejected matter from directly hitting corners 5. In addition, third protrusion 21c is capable of preventing and reducing that the ejected matter is directly supplied to corners 5 by diverting the ejected matter that has collided and contacted with third protrusion 21c. Wall portion 23 is capable of causing the collision, contact, bouncing, redirection, and diffusion of the ejected matter. Wall portion 23 can also separate the ejected matter, and cause the ejected matter to flow and travel along wall portion 23 or recesses 22 on both sides of wall portion 23, and direct and guide the ejected matter in a certain direction. It is possible to cause the ejected matter to flow and travel along wall portion 23 in FIG. 5, for example, second protrusion 21b, or along second recess 22b and third recess 22c on both sides of second protrusion 21b, and direct and guide the ejected matter in a circumferential direction. Wall portion 23 can also separate the ejected matter into recesses 22 on both sides, and disperse and diffuse the ejected matter. Wall portion 23 causes the ejected matter to collide with, bounce off, and contact with wall portion 23, thereby impeding or reducing the straightness of the ejected matter. This reduces and diminishes the kinetic and thermal energy of the ejected matter. Wall portion 23 also diverts the ejected matter, thereby reducing the amount of ejected matter flowing to and reaching the locations where the ejected matter is likely to concentrate, such as corners 5. Therefore, wall portion 23 is capable of efficiently preventing, reducing, and inhibiting the concentration, in corners 5, of the high-temperature and high-pressure ejected matter forcefully ejected.

Wall portion 23 allows the ejected matter to collide and contact with the wall surface efficiently and reliably. Making the wall surface of wall portion 23 curved or flat is unlikely to cause the concentration of the ejected matter. This prevents and reduces the accumulation of the ejected matter. Each corner 5 in angular-shaped outer covering case 2 in FIG. 20 is surrounded by three surfaces (first wall 3, side wall, and top or bottom surface) that are perpendicularly connected. The ejected matter is likely to concentrate and accumulate, in particular, in corner 5. In contrast, in FIG. 5, the surface of wall portion 23 with which the ejected matter collides is cylindrical surface, and the curved portion does not include the portion like angular-shaped corner 5 (FIG. 20). This prompts the ejected matter to smoothly flow without the concentration of the ejected matter. In the case of a protrusion in which the surface of the wall portion with which the ejected matter collides is a flat surface, a shape that does not include a corner or does not cause the concentration of the ejected matter is preferrable. For example, a polygon with a cross-sectional shape of six sided or greater polygon is more preferrable.

The surface (wall surface) of recessed and protruding portion 20 (wall portion 23) in FIG. 5 and the like with which the ejected matter collides may be curved surface 24 that is curved toward central axis 6 of battery cell 1. In FIG. 5, protrusion 21 (wall portion 23), for example, first protrusion 21a, is circular cylindrical portion 25A with central axis 6 of battery cell 1 as a central axis, and includes curved surface 24 that is curved toward central axis 6 of battery cell 1. Curved surface 24 that is curved toward central axis 6 of battery cell 1 can ensure a long curved surface that does not include corner 5 or a portion where connection is made at an acute angle where the ejected matter is likely to concentrate. Curved surface 24 can also diffuse the ejected matter traveling along curved surface 24 while causing the ejected matter to bounce off curved surface 24, thereby reducing the kinetic and thermal energy of the ejected matter. Central axis 6 of battery cell 1 is, for example, central axis 6 in the case of cylindrical battery 1A, and is the line connecting the intersection of the diagonals in the two end surfaces in the case of a prismatic battery. For example, recess 22 can also include curved surface 24, as illustrated in second recess 22b in FIG. 5.

Recessed and protruding portion 20 can include tubular portions 25 that include tubular protrusions 21 or recesses 22. Recessed and protruding portion 20 in FIG. 5 includes three circular cylindrical portions 25A that are, from the center of recessed and protruding portion 20, first protrusion 21a, second protrusion 21b, and third protrusion 21c. Recessed and protruding portion 20 in FIG. 5 includes three circular cylindrical portions 25A having different diameters and arranged concentrically. Three cylindrical portions 25A include first cylindrical portion 25a, second cylindrical portion 25b, and third cylindrical portion 25c from the one positioned nearest to the center and having the smallest diameter. Recessed and protruding portion 20 includes recess 22 between the inside of the smallest cylinder (first cylindrical portion 25a) and protrusion 21. Recesses 22 include, from the center of recesses 22, first recess 22a inside first protrusion 21a, second recess 22b between first protrusion 21a and second protrusion 21b, and third recess 22c between second protrusion 21b and third protrusion 21c. Unlike a rectangular corner, for example, cylindrical portion 25A does not include corner 5, allowing the ejected matter to flow in and out smoothly along the cylindrical curved surface. Cylindrical portion 25A in FIG. 5 is arranged concentrically with battery cell 1. Cylindrical portion 25A (tubular portion 25), which is arranged concentrically with battery cell 1, can cover all directions. By causing the ejected matter ejected from discharge valve 12 or ejected matter that have undergone repeated collision, redirection, and the like to collide and contact with cylindrical portion 25A (tubular portion 25), corners 5 can be protected. In recessed and protruding portion 20 in FIG. 6, second recess 22b and third recess 22c have the same width, and both are elongated, circular, groove-shaped recesses 22. The ejected matter bounces off the wall surfaces of recesses 22, travels within recesses 22, and is dispersed and diffused, so that the pressure of the gas and ejected matter is reduced. Recesses 22 can be differently spaced and shaped. For example, first recess 22a is different in shape from second recess 22b and the like, is positioned on the innermost side, includes a cylindrical recess, and has a diameter larger than the width of second recess 22b and the like. By causing high-pressure and high-temperature gas and ejected matter ejected from battery cell 1 in the direction of central axis 6 to collide with and bounce off the wall surface of first recess 22a that has a wide opening, the pressure of the ejected matter and the like can be reduced. Recess 22 can have a width, shape, and the like suitable for agitation, bouncing, and dispersion of the ejected matter and gas according to the position of opposite surface 3a of first wall 3.

Protrusions 21 and recesses 22 are capable of adjusting the amount of collision, inflow, and flow of the ejected matter that flows into respective recesses 22 between protrusions 21. The height of each protrusion 21 can adjust the amount of collision of the ejected matter and the amount of ejected matter flowing into each recess 22. For example, an increased height of protrusion 21 leads to an increase in the amount of collision of the ejected matter, and a reduced height of protrusion 21 leads to a reduced amount of collision of the ejected matter. An increased height of protrusion 21 leads to an increased amount of ejected matter that flows into recess 22, while a reduced height of protrusion 21 leads to a reduced amount of ejected matter that flows into recess 22. Furthermore, the difference in height of protrusions 21 makes the opening of recess 22 larger, facilitating the inflow of the ejected matter into recess 22. The interval between recesses 22 can adjust the amount of ejected matter that flows in recesses 22. For example, an increase in the interval between recesses 22 leads to an increased amount of ejected matter that flows in recesses 22, and a decrease in the interval between recesses 22 leads to a reduced amount of ejected matter that flows in recesses 22. Recessed and protruding portion 20 can cause the ejected matter that has collided and contacted with protrusions 21 or recesses 22 to bounce off protrusions 21 or recesses 22, redirect the ejected matter, cause the ejected matter to flow along protrusions 21 or recesses 22, and guide the ejected matter. In addition to the basic flow direction, the ejected matter tends to travel in the direction of least resistance to travel. For example, the ejected matter can be directed or guided in the direction where the radius of recessed and protruding portion 20 increases, the width of recess 22 (interval between protrusions 21) increases, the height of protrusion 21 decreases, or the depth of recess 22 decreases.

The height of each protrusion 21 or the depth of each recess 22 (the difference in height in recessed and protruding portion 20) is, for example, at least 1 mm, preferably at least 2 mm, more preferably at least 3 mm. By increasing the height of each protrusion 21, increasing the depth of each recess 22, or increasing the difference in height in recessed and protruding portion 20, it is possible to easily cause the collision, contact, bouncing, inflow, flow, directing, division, and dispersion of the ejected matter. In addition, it is possible to increase the amount of collision and contact of the ejected matter with protrusions 21 or recesses 22, the amount of the ejected matter that flows into recesses 22, and the amount of the ejected matter that flows along protrusions 21 or recesses 22. On the other hand, in order to reduce the size of battery pack 100, the height of each protrusion 21 or the depth of each recess 22 is, for example, preferably at most 3 cm, more preferably at most 2 cm. The thickness of protrusion 21 is, for example, preferably at least 0.1 mm, more preferably at least 0.5 mm, to cause the collision, contact, diffusion, inflow, flow, division, and dispersion of the ejected matter along with the material. The width of recess 22 (the interval between protrusions 21) is, for example, preferably at least 0.5 mm to allow an appropriate amount of ejected matter to flow in and out of recess 22.

The difference in height in recessed and protruding portion 20 is preferably greater than the width of recess 22. By making the height of each protrusion 21 greater than the width of each recess 22 (the interval between protrusions 21), it is possible to efficiently cause the collision, contact, bouncing, redirection, diffusion, inflow, flow, separation, and dispersion of the ejected matter. For example, the ratio of the difference in height in recessed and protruding portion 20 to the width of recess 22 (height difference in recessed and protruding portion 20/width of recess 22) is preferably at least 1.5, more preferably at least 2. The greater the difference in height in recessed and protruding portion 20, the greater the amount of collision, contact, inflow, and flow of the ejected matter. The greater the width of recess 22, the greater the amount of inflow and flow of the ejected matter. The ratio of the difference in height in recessed and protruding portion 20 to the width of recess 22 can adjust the amount of collision, contact, diffusion, dispersion, inflow, and flow of the ejected matter. The number and arrangement of recessed and protruding portion 20 can also be determined within an appropriate range. The difference in height in recessed and protruding portion 20 is preferably greater than the thickness of protrusion 21. This is because making the height of protrusion 21 greater than the thickness (in the width direction) of protrusion 21 efficiently causes the collision, contact, bouncing, redirection, diffusion, inflow, flow, separation, and dispersion of the ejected matter. For example, the ratio of the difference in height in recessed and protruding portion 20 to the thickness of protrusion 21 (height difference in recessed and protruding portion 20/thickness of protrusion 21) is preferably at least 1, more preferably at least 1.5. This is because when the ratio of the height difference in recessed and protruding portion 20 to the thickness of protrusion 21 is less than 1, it is difficult to efficiently cause the collision, contact, bouncing, redirection, diffusion, inflow, flow, separation, dispersion, and the like of the ejected matter.

Recessed and protruding portion 20 can have the same height or depth or different heights and depths. Recessed and protruding portion 20 in FIG. 4 includes three cylindrical portions 25A that are three protrusions 21 (first protrusion 21a, second protrusion 21b, and third protrusion 21c) having different diameters, with recesses 22 (first recess 22a, second recess 22b, and third recess 22c) between respective protrusions 21. As illustrated in FIG. 6, three cylindrical protrusions 21 have the same height. When protrusions 21 have the same height, recesses 22 between protrusions 21 have the same depth. Protrusions 21 having the same height can increase the area where the difference in height between top portion 20a of protrusion 21 and bottom portion 20b of recess 22 is large compared to the case where protrusions 21 include lower protrusions 21. This can also increase the resistance and buffering effects of the ejected matter due to the recessed and protruding shape. In addition, protrusions 21 having the same height can increase the amount of ejected matter that flows into and in recesses 22 between protrusions 21, compared to the case where protrusions 21 include lower protrusions 21. The ejected matter flows into recesses 22, and repeatedly collides and contacts with the walls while flowing, so that the kinetic and thermal energy of the ejected matter can be reduced, and the ejected matter with the reduced energy can be diffused and dispersed. Recesses 22 having the same depth can increase the flow distance and time of the ejected matter within recesses 22 compared to the case where recesses 22 include shallower recesses 22. This contributes to the reduction of the kinetic and thermal energy of the ejected matter and the diffusion and dispersion of the ejected matter with a reduced energy. When protrusions 21 have the same height, the interval (or minimum interval h) between top portion 20a of protrusion 21 and first end surface 15 or battery holder 60 can be made uniformly narrower than when protrusions 21 have different heights. The effect of adiabatic expansion when ejected matter travels from a narrow gap to wide gap 7 can be increased, reducing the kinetic and thermal energy of the ejected matter. The plurality of protrusions 21 having the same height provide a large resistance to the traveling of ejected matter in the direction of the corner straight line, and allows the ejected matter to travel while causing the ejected matter to collide and contact with protrusions or recesses 22 and causing the separation, inflow, flow, and dispersion of the ejected matter. The outflow of the ejected matter that has flown into recess 22 reduces the traveling speed of the ejected matter spreading from the central axis 6 side of battery cell 1 to corners 5, thereby reducing the amount of high-temperature and high-pressure ejected matter supplied to corners 5. In addition, recessed and protruding portion 20 having the same height is easier and less expensive to manufacture.

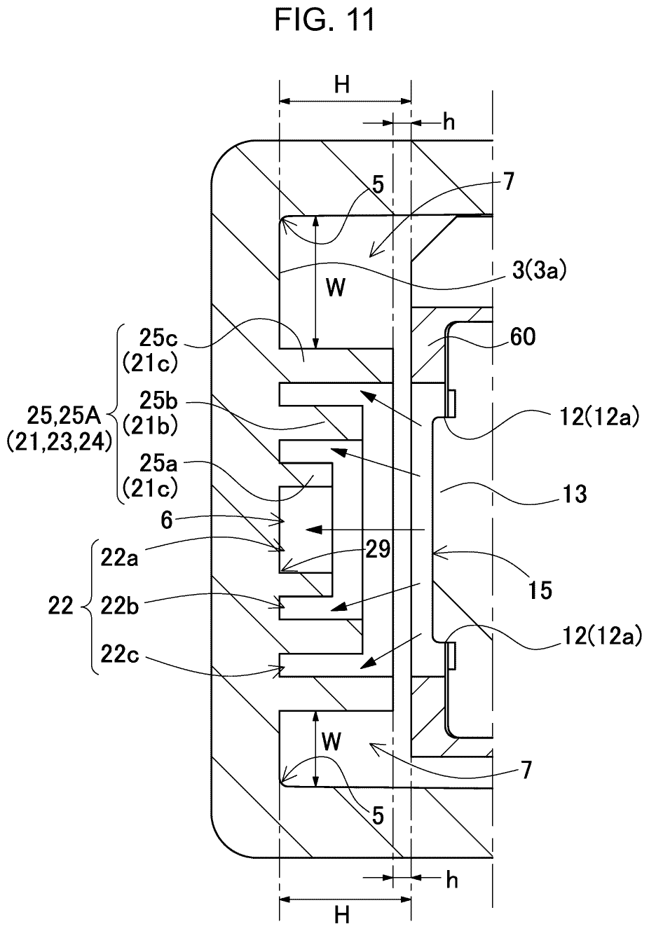

As another example, recessed and protruding portion 20 illustrated in FIG. 10 and FIG. 11 includes three cylindrical protrusions 21 having different heights. Protrusion 21 provided on the outer side is higher than protrusion 21 provided on the inner side. Protrusions 21 illustrated in FIG. 11 are arranged in a bowl shape in which the center side is lower and the outer edge side is higher, and the height increases as the distance from the center of the cylindrical shape increases. The heights of protrusions 21 satisfy the relation of first protrusion 21a<second protrusion 21b<third protrusion 21c. The difference in height of protrusions 21 in FIG. 11 exposes the surface of protrusion 21 with which the ejected matter collide. This facilitates the collision of the ejected matter with each protrusion 21 compared with the case where protrusions 21 have the same height (FIG. 6). The area of opening of each of recesses 22b and 22c in FIG. 11 is greater than when protrusions 21 (FIG. 6) have the same height. This makes it easier for the ejected matter to flow into each of recesses 22. The outermost periphery of recessed and protruding portion 20 in FIG. 11 is the highest protrusion 21 (third protrusion 21c). Outermost protrusion 21 (third protrusion 21c), which is the highest, causes the ejected matter traveling past the inner lower protrusions 21 (first protrusion 21a and second protrusion 21b), the ejected matter traveling from the inner side of recessed and protruding portion 20 to the outer side, and the ejected matter ejected from first end surface 15 at an angle close to the horizontal (XY) direction to collide with and bounce off outermost protrusion 21, preventing the traveling of the ejected matter. As a result, outermost protrusion 21 (third protrusion 21c) prevents and reduces the concentration and accumulation of the ejected matter in the corners that are positioned outside of outermost protrusion 21 (third protrusion 21c). In FIG. 11, protrusions 21 have the same thickness and recesses 22 are equally spaced (have the same width), but may have different thicknesses and different widths. The difference in height between protrusions 21 and the interval between recesses 22 allow adjustment of the amount of ejected matter that collides with protrusions 21 and the amount of ejected matter that flows into and in recesses 22.

Recessed and protruding portion 20 is provided on the inner surface of outer covering case 2, that is, on opposite surface 3a, which is opposite to first end surface 15 of battery cell 1. In outer covering case 2 of FIG. 5, etc., first wall 3 includes opposite surface 3a. By providing recessed and protruding portion 20 on opposite surface 3a that is the inner surface of first wall 3, recessed and protruding portion 20 can easily be arranged in an appropriate position. Recessed and protruding portion 20 in FIG. 5 is provided on opposite surface 3a that is opposite to the front surface of the positive electrode (first end surface 15) of battery cell 1 to provide an anti-diffusion structure for high-temperature ejected matter. By providing protrusions 21 of wall portion 23 or recesses 22 on opposite surface 3a, it is possible to efficiently prevent the high-temperature ejected matter from being diffused. Recessed and protruding portion 20 can also prevent corners 5 from being thermally damaged by reducing the kinetic and thermal energy of the ejected matter. In addition, recessed and protruding portion 20 provided on opposite surface 3a of first wall 3 of outer covering case 2 prevents the diffusion of the high-temperature ejected matter and reduces the kinetic and thermal energy of the ejected matter. This reduces the amount of ejected matter that flows toward adjacent battery cells, thereby preventing fire from spreading to adjacent battery cells due to the ejected matter. According to the arrangement and orientation of battery block 10 where the ejecting and non-ejecting end surfaces of adjacent battery cells 1 are arranged alternately, in outer covering case 2 in FIG. 3, a pair of first walls 3 opposite to first end surfaces 15 of battery cell 1 serve as end surfaces of outer covering case 2 on both sides. However, the first end surfaces of battery cells 1 can be arranged on the same plane. In this case, the first wall that is opposite to the first end surfaces of battery cells 1 can serve as one end surface of the outer covering case.

Recessed and protruding portion 20 is provided at the position where the ejected matter collides with recessed and protruding portion 20. Recessed and protruding portion 20 causes the ejected matter to collide with recessed and protruding portion 20 to redirect, disperse, and diffuse the ejected matter. Recessed and protruding portion 20 also causes the ejected matter to flow and travel along recessed and protruding portion 20, and diverts the ejected matter that travels straight. As a result, the kinetic energy of the ejected matter can be reduced. In addition, recessed and protruding portion 20 can avoid that the high-temperature and high-pressure ejected matter ejected from opening 12a will directly hit and travel to specific locations, such as corners 5, where the ejected matter is likely to accumulate. Causing the ejected matter to collide with recessed and protruding portion 20 prevents the ejected matter from concentrating in specific locations, such as corners 5, and reduces and inhibits the inflow of the ejected matter to specific locations for a certain period of time until the kinetic and thermal energy of the ejected matter is reduced to a certain degree and a certain period of time until the space inside outer covering case 2 is filled with the ejected matter. By providing recessed and protruding portion 20 on opposite surface 3a of first wall 3 of outer covering case 2, recessed and protruding portion 20 can easily be placed in an appropriate position which efficiently prevents thermal failures. This effectively prevents thermal failures of battery cell 1 caused by the ejected matter, in particular, thermal failures that occur in corners 5 of opposite surface 3a that is opposite to first end surface 15 of battery cell 1. Recessed and protruding portion 20 is appropriately positioned to effectively prevent and reduce the concentration of the ejected matter according to, for example, the size, capacity, and shape of battery cell 1, the shape and arrangement of discharge valve 12 and opening 12a, the ejected matter to be ejected, and the direction of the ejection. By arranging recessed and protruding portion 20 concentrically with central axis 6 of battery cell 1, all directions can be covered, including corners 5 positioned outside recessed and protruding portion 20. By making recessed and protruding portion 20 (outermost protrusion 21) larger in diameter than battery cell 1, it is possible to cause the ejected matter ejected outward from first end surface 15 of battery cell 1 to collide with and bounce off recessed and protruding portion 20. By making the diameter of recessed and protruding portion 20 less than or equal to the diameter of battery cell 1 and positioning recessed and protruding portion 20 concentrically with battery cell 1, it is possible to cause the ejected matter ejected from first end surface 15 of battery cell 1 to opposite surface 3a to collide with and bounce off recessed and protruding portion 20. By making the diameter of recessed and protruding portion 20 (outermost protrusion 21) preferably less than or equal to twice the diameter of battery cell 1, more preferably less than or equal to 1.5 times the diameter of battery cell 1, and providing recessed and protruding portion 20 (outermost protrusion 21) at a position that causes a larger amount of ejected matter to collide with and bounce off recessed and protruding portion 20, it is possible to efficiently cause the ejected matter ejected from first end surface 15 of battery cell 1 to collide with and bounce off recessed and protruding portion 20.

Recessed and protruding portion 20 can easily be arranged close to opening 12a of discharge valve 12 by providing recessed and protruding portion 20 on opposite surface 3a of first wall 3 which is opposite to first end surface 15 of battery cell 1. By positioning recessed and protruding portion 20 close to opening 12a of discharge valve 12, it is possible to more effectively prevent and reduce that the ejected matter concentrates and accumulates in corners 5 and thermally melts corners 5. By arranging recessed and protruding portion 20 close to opening 12a of discharge valve 12 and in a position where the ejected matter reliably collides and contacts with recessed and protruding portion 20, it is possible to prevent the ejected matter from directly flowing to corners 5. It is also possible to reduce the amount of ejected matter that flows to corners 5, reduce the kinetic and thermal energy of the ejected matter, and extend the time required for the ejected matter to reach corners 5. Moreover, top portion 20a of protrusion 21 can be positioned close to opening 12a of discharge valve 12, so that the ejected matter that has passed protrusion 21 expands in a large space area and the temperature of the ejected matter is reduced through adiabatic expansion. Moreover, by providing recessed and protruding portion 20 close to opening 12a of discharge valve 12, the range where the collision and contact of the ejected matter forcefully traveling straight occur can be covered without making recessed and protruding portion 20 larger than necessary. This leads to downsizing of battery pack 100.

Recessed and protruding portion 20 can be entirely or partially positioned between opening 12a of discharge valve 12 of battery cell 1 and corner 5 of the inner surface of outer covering case 2 (opposite surface 3a of first wall 3). Recessed and protruding portion 20 provided at this position is capable of protecting corner 5 and preventing and reducing the concentration of ejected matter in corner 5. Between opening 12a of discharge valve 12 of battery cell 1 and corner 5 of the inner surface of outer covering case 2 includes, considering the space inside outer covering case 2 in three dimensions, in any of cross sections including the horizontal (XY) or vertical (Z) direction, or any other specific direction, the case where all or part of recessed and protruding portion 20 is positioned between opening 12a of discharge valve 12 of battery cell 1 and corner 5 of the inner surface of outer covering case 2. For example, when recessed and protruding portion 20 (wall portion 23 of protrusion 21) is positioned on a straight line connecting opening 12a of discharge valve 12 of battery cell 1 and corner 5 of the inner surface of outer covering case 2, wall portion 23 serves as an obstacle to the ejected matter traveling from opening 12a to corner 5. This prevents and reduces the direct hit and direct supply of the ejected matter to corner 5 positioned behind wall portion 23, thereby protecting corner 5. In recessed and protruding portion 20 of FIG. 6, recesses 22 and protrusions 21 are located between first end surface 15 of battery cell 1 and first wall 3 where corner 5 of the inner surface of outer covering case 2 is located, in the central axial direction (Z direction) of battery cell 1. In recessed and protruding portion 20 in FIG. 6, in the direction of diameter (X or Y direction) of battery cell 1, at least third protrusion 21c (third cylindrical portion 25c) and third recess 22c are positioned between opening 12a of discharge valve 12 of battery cell 1 and corner 5 of the inner surface of outer covering case 2. Other than these, in recessed and protruding portion 20 in FIG. 6, in the cross section at any point on the line that connects the shortest interval between opening 12a of discharge valve 12 of battery cell 1 and corner 5 of the inner surface of outer covering case 2, at least a portion of recess 22 or protrusion 21 is positioned between opening 12a of discharge valve 12 of battery cell 1 and corner 5 of the inner surface of outer covering case 2. By positioning recessed and protruding portion 20 between opening 12a of discharge valve 12 and each corner 5 on the inner surface of outer covering case 2, it is possible to efficiently cause the ejected matter to collide and contact with recessed and protruding portion 20. This enables more effective prevention of the concentration of ejected matter in corner 5 and more effective protection of corner 5. The X and Y directions indicate the direction of the diameter of battery cell 1, and the Z direction indicates the direction of the central axis of battery cell 1. For example, in FIG. 5, it is defined that respective sides of outer covering case 2 are the X, Y, and Z directions.

Wall portion 23 in FIG. 6 is arranged in an orientation in which, in the XY plane, the tangent line of the cylindrical curved surface of cylindrical portion 25A extends perpendicularly to a straight line (corner straight line) connecting opening 12a of discharge valve 12 of battery cell 1 to corner 5 of the inner surface of outer covering case 2. Wall portion 23 arranged in such an orientation can increase the amount of collision and contact of the ejected matter, traveling in the direction of the corner straight line, with the wall surface per unit area, and can efficiently reduce the kinetic and thermal energy of the ejected matter. The same advantageous effects can be achieved when wall portion 23 is flat by arranging wall portion 23 in an orientation in which wall portion 23 extends perpendicularly to the corner straight line. Recess 22 adjacent to wall portion 23 has an elongated groove shape extending perpendicularly to the corner straight line. The ejected matter flows and is directed along recess 22, so that the degree of directional change is increased. The ejected matter collides and contacts with walls of recess 22 (or protrusions 21 on both sides), thereby significantly reducing the kinetic and thermal energy of the ejected matter. Protrusion 21 (recess 22) of cylindrical portion 25A is arranged concentrically with central axis 6 of battery cell 1, so that all directions including corner 5 can be covered. Thus, the ejected matter that travels and flows in any directions can be covered, reducing the traveling and supply of the ejected matter from the inside to the outside of recessed and protruding portion 20.

At least a portion of recessed and protruding portion 20 can be provided outside relative to opening 12a of discharge valve 12. In the XY plane of FIG. 6, third protrusion 21c and third recess 22c are positioned outside relative to opening 12a of discharge valve 12. By providing recessed and protruding portion 20 outside relative to opening 12a of discharge valve 12, it is possible to cause the ejected matter to collide and contact with recessed and protruding portion 20. This allows for more effective prevention of the concentration of ejected matter in corners 5 and protection of corners 5. Recessed and protruding portion 20 can include an outer edge that is larger than or equal to the outer edge of opening 12a of discharge valve 12. Recessed and protruding portion 20 in FIG. 6 includes third protrusion 21c and third recess 22c positioned outside relative to opening 12a of discharge valve 12, and includes an outer edge larger than or equal to the outer edge of opening 12a of discharge valve 12. Recessed and protruding portion 20 includes an outer edge that is larger than or equal to the outer edge of opening 12a of discharge valve 12. This causes the ejected matter to collide and contact with recessed and protruding portion 20. This allows for more effective prevention of the concentration of ejected matter in corners 5 and more effective protection of corners 5.

When recessed and protruding portion 20 includes a plurality of recesses and a plurality of protrusions, the recesses and the protrusions can have different thicknesses and intervals. In recessed and protruding portion 20, wall portion 23 of protrusions 21 can have the same thickness or different thicknesses, and recesses 22 can have the same or different widths. Protrusions 21 or recesses 22 can have different thicknesses and widths according to the amount of collision of the ejected matter and the traveling direction of the ejected matter to avoid problems due to thermal runaway. For example, when the recessed and protruding portion includes a plurality of cylindrical portions, the thickness of the wall portion provided on the outer side can be increased compared to the walls provided on the inner side near the center. Moreover, each wall portion 23 of protrusion 21 may have partially different thickness. As illustrated in FIG. 7, for example, in recessed and protruding portion 20, the corners of the base portion (connected portion 29) connected to the inner surface of first wall 3 are rounded (R corners 27). By doing so, the ejected matter can flow smoothly and avoid the concentration of ejected matter in connected portions 29. An increase in thickness of connected portion 29 leads to an increase in strength and heat resistance properties, preventing the ejected matter from penetrating outer covering case 2. In addition, the strength of the connection between recessed and protruding portion 20 and first wall 3 can be increased. The intervals and widths of recesses 22 and the interval between protrusions 21 can also be the same or different. The shape and space at the bottom face of each recess 22 and the thickness of first wall 3 can be adjusted according to the amount of flow, collision, and contact of the ejected matter. Recesses 22 cause the ejected matter to flow and extend the time required for the ejected matter to reach corners 5. In addition, an increase in the thickness of first wall 3 at the bottom face of recess 22 prevents the ejected matter from penetrating outer covering case 2.

Recessed and protruding portion 20 can have the same or different shapes and thicknesses, and a plurality of recessed and protruding portions 20 can be stacked. In the recessed and protruding portion, each protrusion or recess may have, for example, a mesh, net, triangular, quadrangular, polygonal, such as hexagonal, honeycomb, or streamlined shape. In the recessed and protruding portion, protrusions having different shapes can be stacked, and protrusions can be stacked in recesses to make the recessed and protruding portion to have a mesh shape, maze shape, partially lid-shape or the like.

Outer covering case 2 may include gap 7 between the portion of recessed and protruding portion 20 most adjacent to corners 5 and corners 5. Gap 7 in FIG. 6 is provided in outer covering case 2. Gap 7 is a spatial region between the portion of recessed and protruding portion 20 (third protrusion 21c) most adjacent to corners 5 and corners 5 (width W) and defined by the interval (height H) between bottom portion 20b of recess 22 (bottom 20b of third protrusion 21c) and first end surface 15 of battery cell 1 or battery holder 60. The high-temperature and high-pressure ejected matter is held in recessed and protruding portion 20 after the collision, contact, inflow, flow, etc., and gap 7 provided between the portion of recessed and protruding portion 20 (third protrusion 21c) most adjacent to corners 5 and corners 5 (width W) serves as an air layer and protects corners 5. Gap 7 can reduce the temperature of the ejected matter by expanding the volume of the ejected matter flowing out from recessed and protruding portion 20 side towards corners 5 due to adiabatic expansion, preventing and reducing corners 5 from being thermally melted by the high-temperature and high-pressure ejected matter. As illustrated in the cross-sectional view in FIG. 6, gap 7 is defined by a space of height H (in the direction of the central axis of battery cell 1, Z direction) and width W from first wall 3 to battery holder 60. Gap 7 can increase the effects of adiabatic expansion by forming a wide space region (height H) compared to the interval between top portion 20a of protrusion 21 and first end surface 15 of battery cell 1 or battery holder 60, in particular, the minimum interval h between top portion 20a of protrusion 21 and first end surface 15 of battery cell 1 or battery holder 60. The minimum interval h between top portion 20a of recessed and protruding portion 20 (protrusion 21) and first end surface 15 of battery cell 1 or battery holder 60 is preferably, for example, at least 0.5 mm and at most 1 cm. As the ejected matter flows from the narrow minimum interval h into the wide space (height H) of gap 7, the volume of the ejected matter (ejected gas) expands due to adiabatic expansion, thereby reducing the temperature. The recessed and protruding shape of recessed and protruding portion 20 with a narrow minimum interval h serves as resistance to the traveling of the ejected matter forcefully ejected from opening 12a of discharge valve 12 till reaching corners 5. In addition, the adiabatic expansion of gap 7 reduces the kinetic and thermal energy of the ejected matter, contributing to preventing corners 5 from being thermally damaged.

Outer covering case 2 can be integrally formed with recessed and protruding portion 20. When recessed and protruding portion 20 is formed as a separate component, forming, positioning and connecting of recessed and protruding portion 20 are necessary which are not necessary when recessed and protruding portion 20 is formed integrally with outer covering case 2. This leads to lower manufacturing and component costs. By forming recessed and protruding portion 20 in a shape that allows mold forming, manufacturing costs and the manufacturing and assembly processes can be reduced.

Each connected portion 29 in recessed and protruding portion 20 may be curved. For example, connected portions 29 in recessed and protruding portion 20 in FIG. 7 include rounded corners (corners of radius R, R corner 27). By making connected portion 29 between recessed and protruding portion 20 and the inner surface of outer covering case 2 or the connected portions between protrusions and recesses in recessed and protruding portion 20 a curved surface, the ejected matter that has collided with the curved surface can bounce off the curved surface, be redirected, and be diffused smoothly, and the ejected matter can flow along recessed and protruding portion 20 without being disrupted. Such a shape does not cause the ejected matter to concentrate in specific locations, or does not cause the accumulation of the ejected matter in specific locations, thereby preventing the concentration and accumulation of the ejected matter. The rounded corners (R corner 27) can make connected portion 29 thicker and increase the heat resistance and connection strength. Each corner 5 may be rounded.

Protrusions 21 or recesses 22 of recessed and protruding portion 20 can lead, direct and guide the ejected matter in a predetermined direction. Recessed and protruding portion 20 can define the direction of flow of the ejected matter according to the internal design of battery pack 100 such as the layout and space in battery pack 100. Recessed and protruding portion 20 can, for example, lead the ejected matter to a flow path to the outside of outer covering case 2, and avoid the flow to and concentration of the ejected matter in narrow spaces in outer covering case 2 or in portions of outer covering case 2 that might be damaged. In addition, recessed and protruding portion 20 can also guide the ejected matter to an ejecting outlet through which the ejected matter is to be ejected out of outer covering case 2, an area that is spacious, a safe area where it can gain time required for the energy of the ejected matter to attenuate to a certain degree. For example, the wall surface of wall portion 23 can serve as a guide surface or the groove of recess 22 can serve as a guiding groove to direct and guide the ejected matter.

Recessed and protruding portion 20 can include gaps or openings, such as notch 26a, and openings 26b and 26c. Notch 26a is a partial cutout, cutaway, cut-off, or other cutout, opening, or gap between protrusions 21. Each of openings 26b and 26c is an opening, such as a through-hole provided in protrusion 21, a hole, gap, and passage that communicates between recesses 22. Notches 26a, and openings 26b and 26c each allow the ejected matter to pass through protrusion 21, or facilitates traveling of the ejected matter between recesses 22, so that the ejected matter can be dispersed, and directed and guided in a predetermined direction and location. As a result, it is possible to prevent the ejected matter from concentrating in a specific location. Notch 26a, and openings 26b and 26c can direct and guide the ejected matter in directions away from locations where the ejected matter might concentrate in specific locations such as corner 5, in directions where a large internal space region is provided, and in safer directions, according to the positions of notch 26a and openings 26b and 26c. Notch 26a, and openings 26b and 26c can adjust the flow amount and the direction amount of ejected matter according to the sizes and shapes of the openings and gaps.

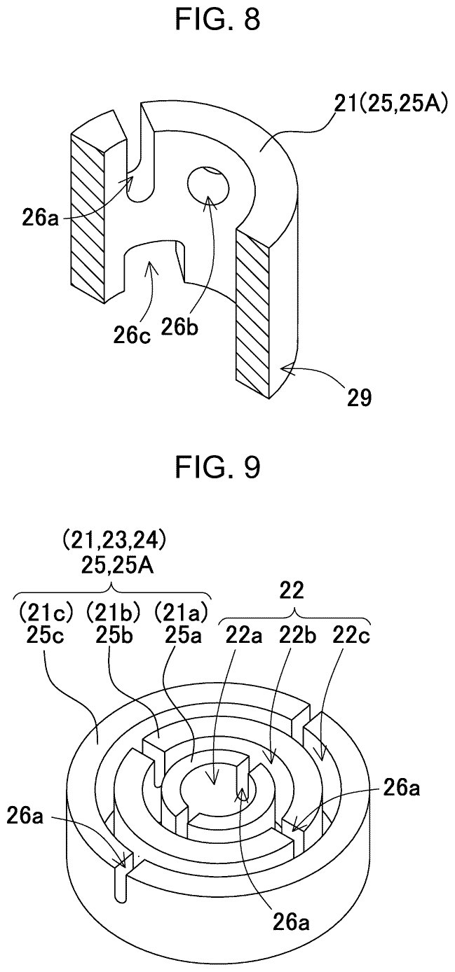

Notch 26a, openings 26b and 26c can be provided, for example, on top portion 20a side of protrusion 21 (notch 26a), in the central portion of protrusion 21 (opening 26b), and near connected portion 29 at the base portion of protrusion 21 (opening 26c), as illustrated in FIG. 8 and FIG. 9. Each notch 26a in FIG. 8 and FIG. 9 is provided on top portion 20a side of protrusion 21, allowing the ejected matter to pass through protrusion 21 and travel between recesses 22. In addition, by dispersing the ejected matter, adjusting the unevenness of the flow amount, and directing the ejected matter, it is possible to prevent the ejected matter from concentrating in specific locations. Notches 26a in FIG. 9, as an example, are provided in protrusions 21 in cross directions, alternating with each other, and adjust the unevenness of the ejected matter and facilitate uniform flow, dispersion, diffusion, and guiding of the ejected matter. However, each notch 26a may be provided at the position that guides the ejected matter in a specific direction. In FIG. 8, opening 26b is provided in the central portion of protrusion 21, and opening 26c is provided near connected portion 29 at the base portion that is connected to the inner surface (first wall 3) of outer covering case 2. In a similar manner to notch 26a, openings 26b and 26c also allow the ejected matter to pass through protrusion 21 and travel between recesses 22, disperse the ejected matter, adjust the unevenness of the flow amount, and direct the ejected matter, preventing the ejected matter from concentrating in specific locations. In particular, by providing a notch or opening 26c at or near connected portion 29 of protrusion 21, it is possible to avoid the concentration of the ejected matter at connected portion 29 between the inner surface (first wall 3) of outer covering case 2 and recessed and protruding portion 20.

### Embodiment 2

FIG. 12 illustrates battery pack 200 according to Embodiment 2. Protrusion 21 or recess 22 in recessed and protruding portion 20 can be entirely or partially shaped with a one-stroke drawing. Single-stroke shaped recessed and protruding portion 20 prevents and reduces the concentration and the accumulation of the ejected matter in specific locations. In FIG. 12, recessed and protruding portion 20 includes protrusion 21 formed by a single stroke of a mosquito repellant coil shape or a spiral shape with a gradually increasing radius from the center. Recess 22 is provided between protrusions 21, and protrusion 21 and recess 22 can have gently curved surfaces. Recessed and protruding portion 20 shaped with a one-stroke drawing and including a gently curved surface can cause the collision, bouncing, redirection, division, and dispersion of the ejected matter and cause the ejected matter to flow along the curved surface. As a result, it is possible to inhibit the concentration and accumulation of the ejected matter. Compared to recessed and protruding portion 20 with cylindrical portions 25A in FIG. 4, spiral-shaped recessed and protruding portion 20 allows for a longer travel distance for the ejected matter to contact with and flow along one recessed and protruding portion 20. Accordingly, the effects of the ejected matter and heat can be diffused without interrupting the flow path of the ejected matter. Moreover, spiral-shaped recessed and protruding portion 20 can guide and direct the ejected matter in a certain direction (e.g., in the direction in which the spiral spreads, toward the outer edge). Recessed and protruding portion 20 can increase the time required for the ejected matter to flow out of recessed and protruding portion 20 while the ejected matter contacts with recessed and protruding portion 20 and travel. Furthermore, unlike the cylindrical shape, spiral-shaped recessed and protruding portion 20 does not cause the ejected matter that has travelled around the spiral shape to collide with each other. Accordingly, single-stroke shaped recessed and protruding portion 20 is capable of more easily guiding and directing the ejected matter in a certain direction, preventing and reducing the concentration and the accumulation of the ejected matter in specific locations. Recesses 22 in FIG. 12 are spaced approximately equally, but they may be spaced differently. For example, the closer to the outer edge, the wider or narrower the interval between recesses 22, and the amount of inflow and flow of the ejected matter can be adjusted and the ejected matter can be directed in the flow direction. A single stroke is not limited to a curved line in the cross-sectional shape, but can be a straight line or a combination of straight and curved lines. Recessed and protruding portion 20 can be entirely or partially shaped with a one-stroke drawing. In the description, circular or tubular shape includes the meaning of spiral or mosquito repellent coil shape.

### Embodiment 3 and Embodiment 4

FIG. 13 illustrates battery pack 300 according to Embodiment 3. Recessed and protruding portion 20 can include protrusions 21 or recesses 22 having different shapes, and protrusions 21 having different shapes or recesses 22 having different shapes can be combined. As an example, recessed and protruding portion 20 in FIG. 13 includes protrusion 21 that is cylindrical portion 25A at the outer edge; and a plurality of protrusions 21 that are positioned inside cylindrical portion 25A, are blades curved in certain directions, and extend from the center to the outer edge. Protrusions 21, which are a plurality of curved blades, can be made of a plurality of S-shaped propellers connected at the center. In a similar manner to the case of the single stroke shape in FIG. 12, recessed and protruding portion 20 including the blades is capable of preventing and reducing the concentration and accumulation of the ejected matter in specific locations. Protrusions 21, which are curved blades, can cause the ejected matter to collide with and bounce off protrusions 21, and can redirect, divide, and disperse the ejected matter. Protrusions 21 can also cause the ejected matter to flow along the curves (curved surfaces) and can direct the ejected matter toward the outer edge where the interval between protrusions 21 is wider. Protrusions 21 can further cause the ejected matter to smoothly flow in certain directions while causing the ejected matter to collide and contact with protrusion 21 that is cylindrical portion 25A on the outer edge.

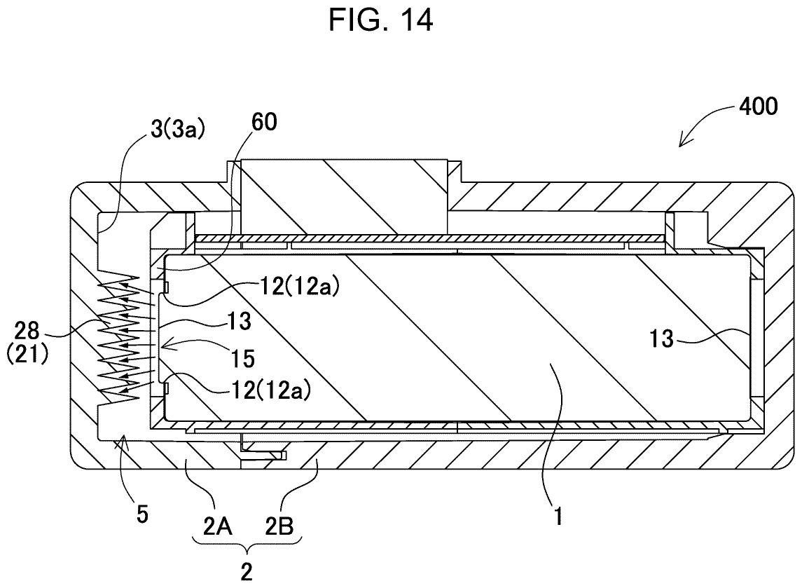

The example has been described above in which recessed and protruding portion 20 is wall-shaped. However, the present disclosure is not limited to the wall-shaped recessed and protruding portion, but may be other shapes, e.g., projection shape. FIG. 14 illustrates, as an example, battery pack 400 according to Embodiment 4. Each protrusion 21 of recessed and protruding portion 20 is partially protruding projection 28. Projections 28 each may have an approximately bar shape, for example, having approximately the same diameter, width, thickness, height, shape and the like, or may have a tapered shape, such as a circular cone, and a square cone, having different diameters, widths, thicknesses, heights, shapes, and the like. For example, recessed and protruding portion 20 in FIG. 14 includes protrusions 21 that are a plurality of partial projections 28. When recessed and protruding portion 20 of projection 28 is conical, connected portion 29 is connected at an obtuse or gentle surfaces instead of a right angle. This avoids and inhibits the concentration and accumulation of the ejected matter. Projections 28 can redirect, divide, and diffuse the ejected matter that travels straight and collides with projections 28. Conical projection 28 can increase the diameter and thickness of connected portion 29 connected with the bottom face (first wall 3), increasing the connection strength and preventing the ejected matter from penetrating outer covering case 2. The diameter, width, and thickness of each projection 28 can vary in part, such as inverse taper shape or a shape in which the top portion and the connected portion at the base portion is thicker than the central portion

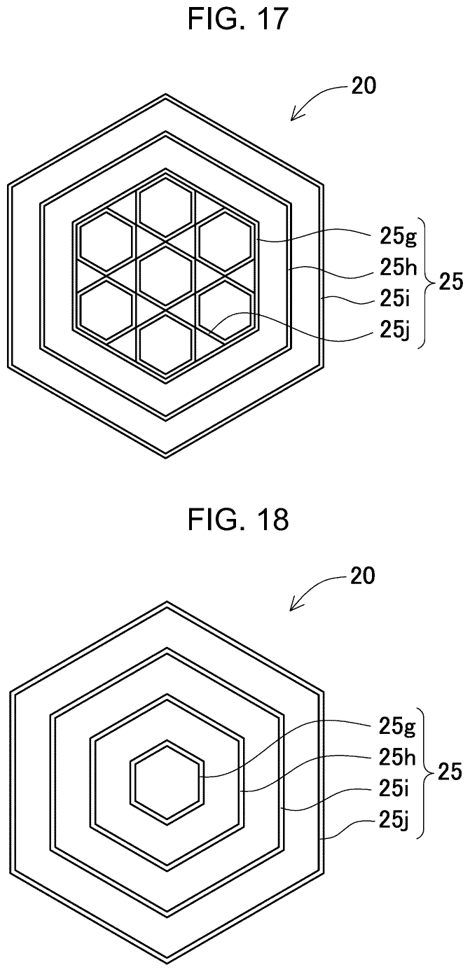

Recessed and protruding portion 20 can include protrusions 21 or recesses 22 having different shapes or sizes. For example, recessed and protruding portion 20 can include a combination of protrusion 21 that is partial projection 28 and protrusion 21 of wall portion 23. Recessed and protruding portion 20 can include one or more partial projections 28 and one or more wall portion 23 that surround projections 28. Recessed and protruding portion 20 can include a plurality of wall portion 23 having different shapes or sizes. Recessed and protruding portion 20 can include protrusions of wall portions, cylindrical tubular portions, and circular tubular portions positioned at the outer edge or other positions. FIG. 15 to FIG. 18 illustrate these examples. Protruded and recessed portion 20 in FIG. 15 includes three cylindrical portions 25A and a plurality of partial projections 28, three cylindrical portions 25A (namely, first cylindrical portion 25d, second cylindrical portion 25e, and third cylindrical portion 25f from the center of protruded and recessed portion 20) having different diameters located closer to the outer edge than the plurality of partial projections 28 and the plurality of partial projections 28 located closer to the center of protruded and recessed portion 20 than the cylindrical portions 25A. In this configuration, a large number of projections 28 are provided on opposite surface 3a of first wall 3 with which high-pressure and high-temperature gas and ejected matter among the ejected matter released from battery cell 1 directly contacts. This agitates the ejected matter and gas and reduces the pressure, reducing the pressure of the ejected matter and the like that bounces off and is dispersed in the surrounding area. Recessed and protruding portions 20 illustrated in FIG. 16 and FIG. 17 each include three hexagonal tubular portions and a plurality of hexagonal fourth tubular portions 25j, the three hexagonal tubular portions having different sizes located closer to the outer edge than a plurality of hexagonal fourth tubular portions 25j (first cylindrical portion 25g, second cylindrical portion 25h, and third cylindrical portion 25i from the center of protruded and recessed portion 20) and a plurality of hexagonal fourth tubular portions 25j (seven in FIG. 16 and FIG. 17) located closer to the center of protruded and recessed portion 20 than three hexagonal tubular portions. Recessed and protruding portions 20 in FIGS. 16 and 17 differ in the positions of the plurality of (seven in FIG. 16 and FIG. 17) hexagonal fourth tubular portions 25j located on the inner side of protruded and recessed portion 20. In each of FIG. 15 to FIG. 7, wall-shaped tubular portions 25 and elongated groove-shaped recesses 22 are provided on the outer edge side of protruded and recessed portion 20, and projections 28 or tubular portions 25 smaller than the outer ones are provided on the inner side. Agitation, bouncing, and dispersion of the ejected matter and gas are caused according to the position of opposite surface 3a of first wall 3 with which high-pressure and high-temperature gas and ejected matter directly contact, so that the pressure of the ejected matter and the like is reduced. By providing projections 28 or wall portion 23 in groove-shaped recesses 22 in recessed and protruding portion 20, it is possible to cause agitation and bouncing of the ejected matter and gas in recesses 22, thereby reducing the pressure of the ejected matter and the like. Recessed and protruding portion 20 in FIG. 18 includes four hexagonal tubular portions 25 having different sizes (first tubular portion 25g, second tubular portion 25h, third tubular portion 25i, and fourth tubular portion 25j from the inner side). In this configuration, with four tubular portions 25 that is greater in number than three cylindrical portions 25A (FIG. 4), wall portion 23 and elongated groove-shaped recesses 22 can obtain more effects of bouncing, redirection, division, dispersion, and direction of the ejected matter and gas. Each protrusion 21 or recess 22 in recessed and protruding portion 20 may have a polygonal shape other than the hexagonal shape. With this configuration, according to the position of opposite surface 3a of first wall 3 with which the high-pressure and high-temperature gas or ejected matter directly contact, it is possible to provide protrusions 21 or recesses 22 with shapes suitable for agitation, bouncing, and dispersion of the ejected matter and gas.

### INDUSTRIAL APPLICABILITY

The present disclosure can be effectively used as a battery pack that prevents thermal failures caused by high-temperature ejected matter ejected from the discharge valve of a battery cell.

### REFERENCE MARKS IN THE DRAWINGS

100, 200, 300, 400, 900 battery pack
1 battery cell
1A cylindrical battery
2 outer covering case
2A, 2B divided case
3 first wall
3a opposite surface
5 corner
6 central axis
7 gap
10 battery block
12 discharge valve
12a opening
13 electrode
15 first end surface
20 recessed and protruding portion
20a top portion
20b bottom portion
21 protrusion
21a first protrusion
21b second protrusion
21c third protrusion
22 recess
22a first recess
22b second recess
22c third recess
23 wall portion
24 curved surface
25 tubular portion
25A cylindrical portion
25a first cylindrical portion
25b second cylindrical portion
25c third cylindrical portion
25d first cylindrical portion
25e second cylindrical portion
25f third cylindrical portion
25g first tubular portion
25h second tubular portion
25i third tubular portion
25j fourth tubular portion
26a notch
26b opening
26c opening
27 R corner
28 projection
29 connected portion
60 battery holder
62 insertion tube
901 battery cell
902 outer covering case
903 first wall
903a opposite surface
904A first side wall
904B second side wall
904C top surface
905, 905A corner
912 discharge valve
912a opening
915 first end surface

1. A battery pack comprising:
a battery block that includes a battery cell that includes an opening of a discharge valve on an end surface of the battery cell; and
an outer covering case that houses the battery block,
wherein the outer covering case includes a recessed and protruding portion on an opposite surface of the outer covering case, the opposite surface being opposite to the end surface of the battery cell, and
the recessed and protruding portion includes a top portion that is closer to the end surface of the battery cell and a bottom portion that is farther away from the end surface of the battery cell, and the top portion and the bottom portion are different in height in a direction perpendicular to the end surface of the battery cell.

2. The battery pack according to claim 1,
wherein the recessed and protruding portion includes one or more protrusions or one or more recesses.

3. The battery pack according to claim 1,
wherein a portion of the recessed and protruding portion overlaps with a line connecting the opening of the discharge value of the battery cell and a corner of an inner surface of the outer covering case.

4. The battery pack according to claim 1,
wherein the top portion and the bottom portion of the recessed and protruding portion are different in height by at least 1 mm.

5. The battery pack according to claim 1,
wherein the recessed and protruding portion includes a plurality of protrusions or a plurality of recesses, and
the plurality of protrusions are different in height or the plurality of recesses are different in depth.

6. The battery pack according to claim 1,
wherein the recessed and protruding portion includes a wall.

7. The battery pack according to claim 6,
wherein the recessed and protruding portion includes a curved surface that is curved with respect to a central axis of the battery cell.

8. The battery pack according to claim 7,
wherein an outermost periphery of the recessed and protruding portion is a highest protrusion that includes the curved surface.

9. The battery pack according to claim 6,
wherein the recessed and protruding portion includes a tubular portion.

10. The battery pack according to claim 6,
wherein the recessed and protruding portion is shaped with a one-stroke drawing in plan view.

11. The battery pack according to claim 6,
wherein the wall of the recessed and protruding portion includes a notch.

12. The battery pack according to claim 6,
wherein the wall of the recessed and protruding portion includes an opening.

13. The battery pack according to claim 6,
wherein the battery cell is a cylindrical battery.
